(19) United States
(12) Patent Application Publication
(10) Pub. No.: US 2024/0231162 A1
(43) Pub. Date: Jul. 11, 2024

(54) GRADIENT-INDEX LIQUID CRYSTAL LENS SYSTEM INCLUDING GUEST-HOST LIQUID CRYSTAL LAYER FOR REDUCING LIGHT LEAKAGE

(71) Applicant: Meta Platforms Technologies, LLC, Menlo Park, CA (US)

(72) Inventors: Weihua Gao, Rancho Santa Margarita, CA (US); Dmytro Y Reznikov, Oakland, CA (US); Afsoon Jamali, Issaquah, WA (US); Amit Bhowmick, Kent, OH (US); Eric Stratton, Snohomish, WA (US); Yakov Soskind, Plainsboro, NJ (US); Gary D Sharp, Boulder, CO (US); Tony Donal McGettigan, Boulder, CO (US)

(21) Appl. No.: 18/512,976

(22) Filed: Nov. 17, 2023

Related U.S. Application Data
(60) Provisional application No. 63/479,394, filed on Jan. 11, 2023.

(51) Int. Cl. G02F 1/1347; G02F 1/137; G02F 1/29

(52) U.S. Cl. CPC G02F 1/13471; G02F 1/13725; G02F 1/294

(57) ABSTRACT

A lens system may include a lens and a leakage-reduction element overlapping the lens. The lens may include a driving electrode array, a common electrode, and a lens liquid crystal layer disposed between the driving electrode array and the common electrode. The leakage-reduction element may include a guest-host liquid crystal layer having dye molecules in a liquid crystal solution. A display device may include a display screen, which has a plurality of light emitting elements, and a lens system that receives light emitted from the display screen. Various other devices, systems, and methods are also disclosed.

### CROSS-REFERENCE TO RELATED APPLICATIONS

This application claims the benefit of and priority to U.S. Provisional Patent Application No. 63/479,394, filed 11 Jan. 2023, and titled GRADIENT-INDEX LIQUID CRYSTAL LENS SYSTEM INCLUDING GUEST-HOST LIQUID CRYSTAL LAYER FOR REDUCING LIGHT LEAKAGE, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1A illustrates a relationship between vergence and accommodation in the real world according to some embodiments.

FIG. 1B illustrates a conflict between vergence and accommodation in a three-dimensional (3D) display screen according to some embodiments.

FIG. 2A is a perspective view of an example head-mounted display according to some embodiments.

FIG. 2B is a cross-sectional view of a front rigid body of the head-mounted display shown in FIG. 2A according to some embodiments.

FIG. 3 is a diagram illustrating light refracted through an example gradient-index liquid crystal (GRIN LC) lens according to some embodiments.

FIG. 4 is a cross-sectional diagram illustrating the structure of an example GRIN LC lens according to some embodiments.

FIG. 5 is a plot illustrating a curve of optical path difference versus voltage utilized to obtain a desired liquid phase profile according to some embodiments.

FIG. 6A illustrates an example GRIN LC lens according to some embodiments.

FIG. 6B illustrates an example GRIN LC lens having two Fresnel reset regions according to some embodiments.

FIG. 7A is a plot showing an ideal parabolic phase profile for an example GRIN LC lens according to some embodiments.

FIG. 7B is a plot showing a 2-dimensional (2D) phase map for an example GRIN LC lens having five Fresnel resets according to some embodiments.

FIG. 8 illustrates an example GRIN LC lens including five Fresnel reset sections for producing five Fresnel resets as shown in FIG. 7B according to some embodiments.

FIG. 9A is a plot showing an ideal parabolic phase profile for an example large-diameter GRIN LC lens according to some embodiments.

FIG. 9B is a plot showing a 2D phase map for an example large-diameter GRIN LC lens having 28 Fresnel resets according to some embodiments.

FIG. 10A illustrates an example GRIN LC system that includes an electrode array and a plurality of bus lines according to some embodiments.

FIG. 10B shows a close-up view of a portion of the GRIN LC system illustrated in FIG. 10A according to some embodiments.

FIG. 11 illustrates light-scattering regions and Fresnel resets of an example GRIN LC lens according to some embodiments.

FIG. 12 illustrates an example leakage-reduction element of a GRIN LC system according to some embodiments.

FIG. 13A illustrates a portion of an example lens system including a GRIN LC lens and a first light-blocking section of a leakage-reduction element according to some embodiments.

FIG. 13B illustrates a portion of the example lens system of FIG. 13A including a second light-blocking section of the leakage-reduction element according to some embodiments.

FIG. 14A illustrates a first light-blocking section of a leakage-reduction element according to some embodiments.

FIG. 14B illustrates a second light-blocking section of the leakage-reduction element illustrated in FIG. 14A according to some embodiments.

FIG. 15A illustrates a light-blocking section of a leakage-reduction element in a first state according to some embodiments.

FIG. 15B illustrates the light-blocking section illustrated in FIG. 15A in a second state according to some embodiments.

FIG. 16 is a flow diagram of an exemplary method for manufacturing a GRIN LC system according to some embodiments.

FIG. 17 is an illustration of an exemplary varifocal system that may be used in connection with embodiments of this disclosure.

FIG. 18 is an illustration of exemplary augmented-reality glasses that may be used in connection with embodiments of this disclosure.

FIG. 19 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Artificial reality devices, such as virtual reality headsets, can be used to simulate and/or reproduce a variety of virtual and remote environments. For example, stereoscopic images can be displayed on an electronic display inside a headset to simulate the illusion of depth, and head tracking sensors can be used to estimate what portion of the virtual environment is being viewed by the user. However, because existing headsets are often unable to correctly render or otherwise compensate for vergence and accommodation conflicts, such simulation can cause visual fatigue and discomfort for the users. Augmented reality and mixed reality headsets may display a virtual image overlapping with real-world images. To create a comfortable viewing experience, virtual images generated by such headsets are typically displayed at distances suitable for eye accommodations of real-world images in real time during the viewing process.

Vergence-accommodation conflict is a common problem in artificial reality systems, including virtual, augmented, and mixed reality systems. “Accommodation” is a process of adjusting the focal length of an eye lens. During accommodation, the optics of an eye are adjusted to keep an object in focus on the retina as its distance from the eye varies. “Vergence” is the simultaneous movement or rotation of both eyes in opposite directions to obtain or maintain binocular vision and is connected to accommodation of the eye. Under normal conditions, when human eyes look at a new object at a distance different from an object they had been looking at, the eyes automatically change focus (by changing their shape) to provide accommodation at the new distance or vergence distance of the new object.

In accordance with various embodiments, disclosed display devices may include gradient-index liquid crystal (GRIN LC) lenses that utilize variations in liquid crystal alignment to refract light in a manner similar to conventional lenses. A GRIN LC lens, as disclosed herein, may include an electrode array that provides variations in voltages applied to a liquid crystal layer of the lens, with the variations producing a voltage gradient(s) proceeding from a center of the lens outward. Voltages applied to the liquid crystal layer may be selectively changed so as to generate different lens powers corresponding to active display conditions and/or user eye orientation. Accordingly, GRIN LC lenses, as disclosed herein, may address the vergence-accommodation conflict by compelling a user's eyes to focus at a focal distance coinciding with a vergence location of a virtual object displayed by the display device. Moreover, since the lens diopter is not determined solely by a surface shape of a GRIN LC lens, thicknesses of the disclosed GRIN LC lenses may be significantly reduced in comparison to conventional lenses.

GRIN LC lenses having large diameters may be desirable in various devices to provide a sufficient aperture. However, as the lens diameter increases, the necessary lens thickness and required voltage drop may also increase. Additionally, the required reset time may be excessively long in such larger diameter lenses. In order to produce larger diameter lenses, Fresnel resets may be included in the lens architecture. The Fresnel resets may allow for thinner GRIN LC lenses that have sufficiently fast response times. However, transition regions between Fresnel reset sections may diffract and scatter light in undesired directions, causing unpleasant image artifacts and/or distortions that are noticeable to viewers. While dark masking layers may be used to block scattered light at the transition regions, such masking layers may be visible to viewers so as to interfere with their viewing experience.

In accordance with embodiments disclosed herein, a lens system may include a GRIN LC lens and a leakage-reduction element overlapping the GRIN LC lens. The leakage-reduction element may include a guest-host liquid crystal (GHLC) layer having dye molecules dispersed in the liquid crystal solution. The dye molecules may be oriented based on orientations of nearby liquid crystal molecules in the GHLC layer. In some examples, dye molecules in first light-blocking sections of the leakage-reduction element may be oriented to block light scattered from, for example, the transition regions between Fresnel reset regions. The first light-blocking sections may overlap the transition regions of the GRIN LC lens. In various examples, the leakage-reduction element may also include second light-blocking sections located between the first light-blocking sections. Dye molecules in the second light-blocking sections may be oriented differently than dye molecules in the first light-blocking sections such that the second light-blocking sections act as polarization filters. More particularly, dye molecules in the second light-blocking sections may be oriented in a selected direction(s) to primarily allow passage of light having a particular polarization state while blocking other polarization states of light. Orientations of liquid crystal and dye molecules in each of the first and second light-blocking sections may be directed by alignment layers abutting the GHLC layers and/or by electric fields generated by electrodes overlapping the GHLC layers.

Leakage-reduction elements, as disclosed herein, may obviate the need to use a dark masking layer to block undesirable light scattering. Thus, optical characteristics of GRIN LC lenses having Fresnel resets may be improved, resulting in reduced light scattering and increased clarity in comparison to lenses utilizing masking layers. Visible lines, such as those evident on a dark masking layer, may not be present in the disclosed lens systems, which permit light passage through each of the first and second light-blocking regions. The thickness of a leakage-reduction element, as described herein, may be comparatively thin and, in some examples, may also function as a polarization layer. Accordingly, the lens systems described herein may have minimal space requirements, making them suitable for use in a variety of display systems, including various head-mounted display systems.

Features from any of the embodiments described herein may be used in combination with one another in accordance with the general principles described herein. These and other embodiments, features, and advantages will be more fully understood upon reading the following detailed description in conjunction with the accompanying drawings and claims.

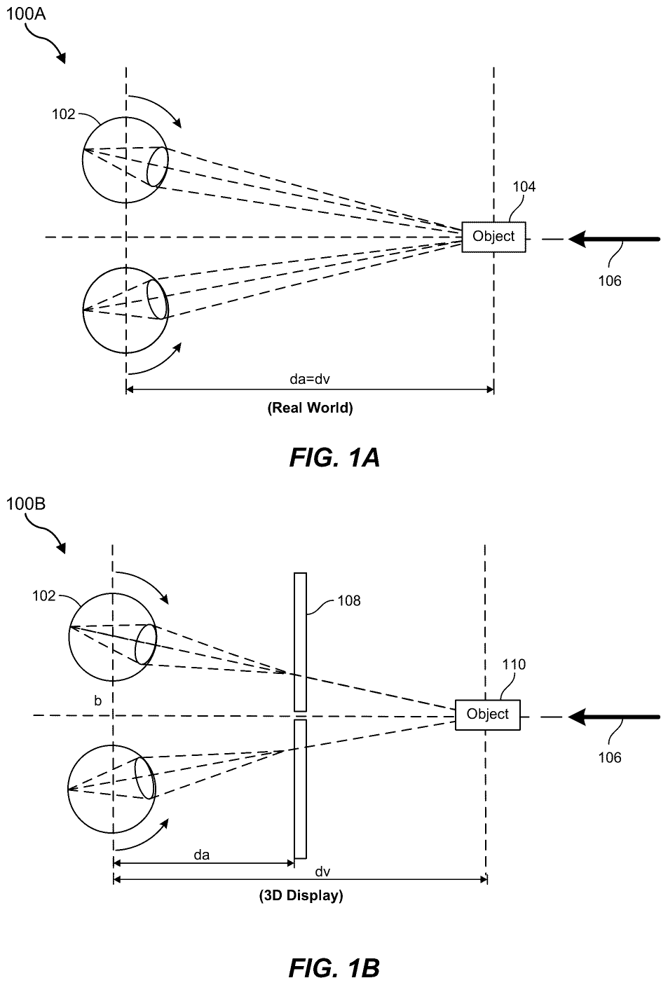

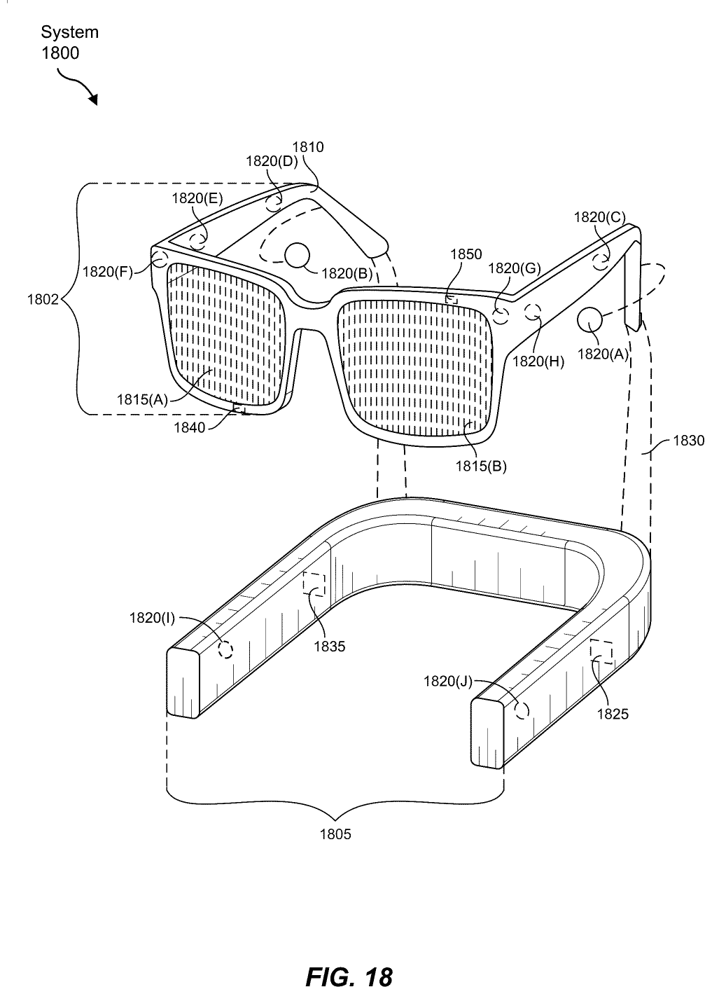

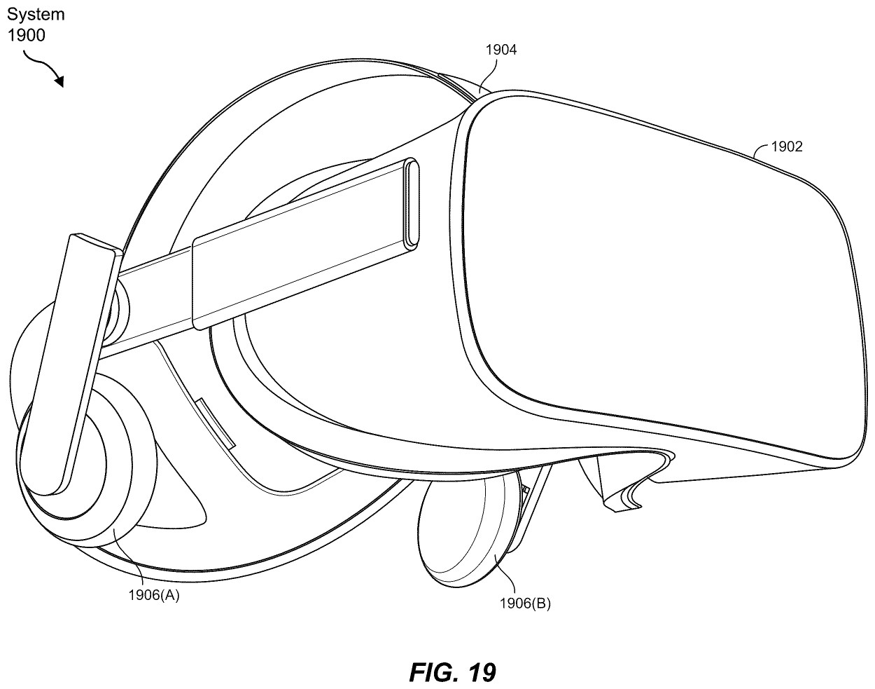

The following will provide, with reference to FIGS. 1-19, a detailed description of GRIN LC lenses and systems. The discussion associated with FIGS. 1-17 relates to the architecture, operation, and manufacturing of various example GRIN LC lenses and systems. The discussion associated with FIGS. 18 and 19 relates to exemplary virtual reality and augmented reality devices that may include GRIN LC lenses as disclosed herein.

FIG. 1A shows a diagram 100A illustrating an example of how the human eye experiences vergence and accommodation in the real world. As shown in FIG. 1A, a user is looking at a real object 104 such that the user's eyes 102 are verged on real object 104 and gaze lines from the user's eyes 102 intersect at real object 104. As real object 104 is moved closer to the user's eyes 102 (as indicated by arrow 106), each eye 102 rotates inward (i.e., convergence) to stay verged on real object 104. As real object 104 gets closer, the user's eyes 102 accommodate for the closer distance by changing their shape to reduce the power or focal length. The distance at which the eyes 102 must be focused to create a sharp retinal image is the accommodation distance. Thus, under normal conditions in the real world, the vergence distance (dv) is equal to the accommodation distance (da).

FIG. 1B shows a diagram 100B illustrating an example conflict between vergence and accommodation that can occur with conventional three-dimensional displays. As shown in FIG. 1B, a user is looking at a virtual object 110 displayed on an electronic screen(s) 108. The user's eyes 102 are verged on virtual object 110 (gaze lines from the user's eyes 102 are shown intersecting at virtual object 110). However, virtual object 110 is located at a greater distance from the user's eyes 102 than electronic screen(s) 108. As virtual object 110 is rendered on the electronic screen(s) 108 to appear closer to the user, each eye 102 again rotates inward to stay verged on virtual object 110, but the power or focal length of each eye 102 is changed accordingly. Hence, the user's eyes may not accommodate in the manner illustrated in FIG. 1A. As such, instead of changing power or focal length to accommodate for the further vergence distance dv associated with virtual object 110, each eye 102 maintains accommodation at a closer accommodation distance da associated with electronic screen(s) 108. Thus, the vergence distance dv may not be equal to the accommodation distance da for the human eye for objects displayed on 2-dimensional electronic screens. This discrepancy between vergence distance dv and accommodation distance da is commonly referred to as “vergence-accommodation conflict.” A user experiencing only vergence or accommodation, but not both simultaneously, with respect to a virtual object may undesirably experience eye fatigue and discomfort during use.

“Optical series,” as used herein, may refer to relative positioning of a plurality of optical elements such that light, for each optical element of the plurality of optical elements, is transmitted by that optical element before being transmitted by another optical element of the plurality of optical elements. For embodiments described herein, optical elements may be aligned in various arrangements without regard to a specific ordering within an optical series. For example, optical element A placed before optical element B, or optical element B placed before optical element A, may both be in optical series with each other. An optical series may represent a combination of optical elements having individual optical properties that are compounded with each other when placed in series.

As used herein, a material or element that is “transparent” or “optically transparent” may, for a given thickness, have a transmissivity within the visible light spectrum of at least approximately 70%, e.g., approximately 70, 80, 90, 95, 97, 98, 99, or 99.5%, including ranges between any of the foregoing values, and less than approximately 10% bulk haze, e.g., approximately 0.5, 1, 2, 4, 6, or 8% bulk haze, including ranges between any of the foregoing values. In accordance with some embodiments, a “fully transparent” material or element may have (a) a transmissivity (i.e., optical transmittance) within the visible light spectrum of at least approximately 90%, e.g., approximately 90, 95, 97, 98, 99, or 99.5%, including ranges between any of the foregoing values, (b) less than approximately 5% bulk haze, e.g., approximately 0.1, 0.25, 0.5, 1, 2, or 4% bulk haze, including ranges between any of the foregoing values, (c) less than approximately 30% reflectivity, e.g., approximately 1, 2, 5, 10, 15, 20, or 25% reflectivity, including ranges between any of the foregoing values, and (d) at least 70% optical clarity, e.g., approximately 70, 80, 90, 95, 97, 98, 99, or 99.5% optical clarity, including ranges between any of the foregoing values. Transparent and fully transparent materials will typically exhibit very low optical absorption and minimal optical scattering. In some embodiments, “transparency” may refer to internal transparency, i.e., exclusive of Fresnel reflections.

As used herein, the terms “haze” and “clarity” may refer to an optical phenomenon associated with the transmission of light through a material, and may be attributed, for example, to the refraction of light within the material, e.g., due to secondary phases or porosity and/or the reflection of light from one or more surfaces of the material. As will be appreciated by those skilled in the art, haze may be associated with an amount of light that is subject to wide angle scattering (i.e., at an angle greater than 2.5° from normal) and a corresponding loss of transmissive contrast, whereas clarity may relate to an amount of light that is subject to narrow angle scattering (i.e., at an angle less than 2.5° from normal) and an attendant loss of optical sharpness or “see through quality.”

A material or element that is “reflective” or “optically reflective” may, for example, have a transmissivity within the visible light spectrum of less than approximately 2%, e.g., less than 2, 1, 0.5, 0.2, or 0.1%, including ranges between any of the foregoing values.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

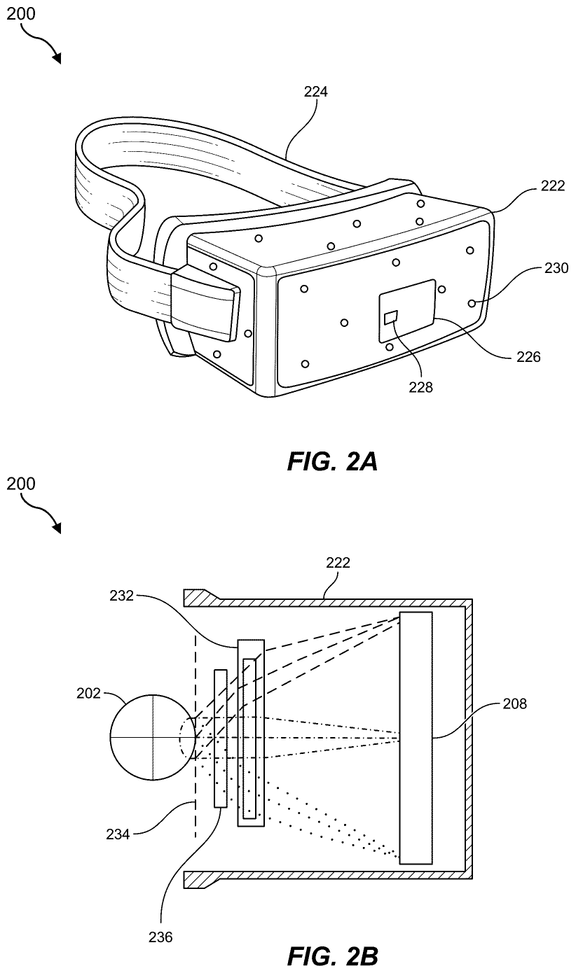

FIG. 2A shows an example head-mounted display (HMD) 200 in accordance with some embodiments. As shown in FIG. 2A, the HMD 200 may include a front rigid body 222 and a band 224. The front rigid body 222 may include one or more electronic display elements of an electronic display, an inertial measurement unit (IMU) 226, one or more position sensors 228, and locators 230. In the example shown in FIG. 2A, position sensors 228 may be located within IMU 226, and neither IMU 226 nor position sensors 228 may be visible to a user on the device exterior. HMD 200 may, for example, function as a virtual reality device, an augmented reality device, and/or a mixed reality device. In some examples, when HMD 200 acts as an augmented or mixed reality device, portions of HMD 200 and its internal components may be at least partially transparent.

FIG. 2B is a cross-sectional view of the exemplary embodiment of HMD 200 shown in FIG. 2A. As shown in FIG. 2B, front rigid body 222 may include an electronic display 208, a varifocal block 232, and, in some examples, an eye-tracking system 236. Electronic display 208 may display images (i.e., virtual scenes) to a user wearing HMD 200. In some embodiments, electronic display 208 may include a stack of one or more waveguide displays including, but not limited to, a stacked waveguide display.

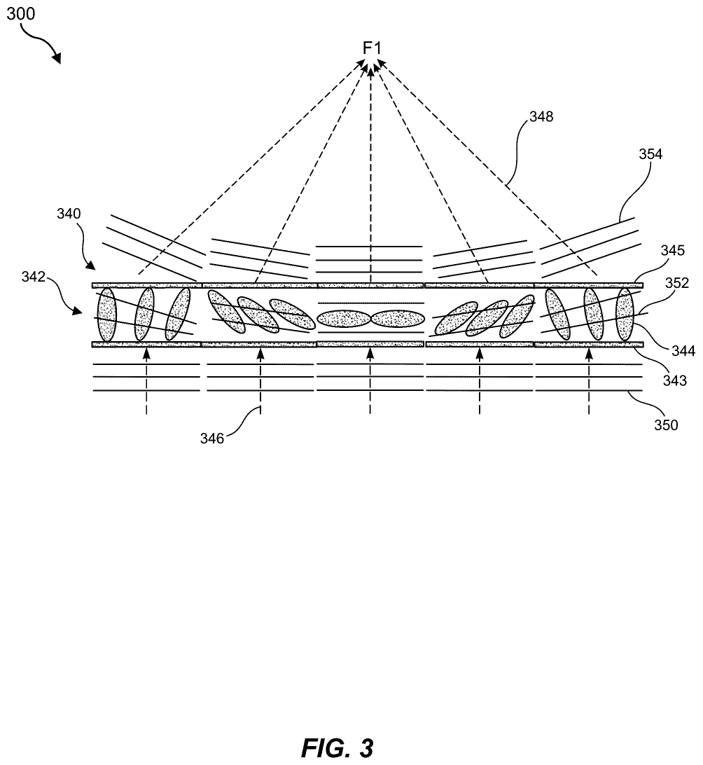

Varifocal block 232 may include one or more varifocal structures in optical series. A varifocal structure is an optical device that is configured to dynamically adjust its focus in accordance with instructions from a varifocal system. In some examples, varifocal block 232 may include a GRIN LC lens as disclosed herein (see, e.g., FIGS. 3-12). Electronic display 208 and varifocal block 232 together provide image light to an exit pupil 234. Eye-tracking system 236 may include, e.g., one or more sources that illuminate one or both eyes of the user and one or more cameras that capture images of one or both eyes of the user. Eye-tracking system 236 may detect a location of an object in the virtual scene at which the user's eye 202 is currently looking. Exit pupil 234 may be the location of front rigid body 222 where a user's eye 202 is positioned. For purposes of illustration, FIG. 2B shows a cross section of front rigid body 222 associated with a single eye 202, but another portion of varifocal block 232 or another varifocal block, which is separated from varifocal block 232, may provide altered image light to another eye of the user.

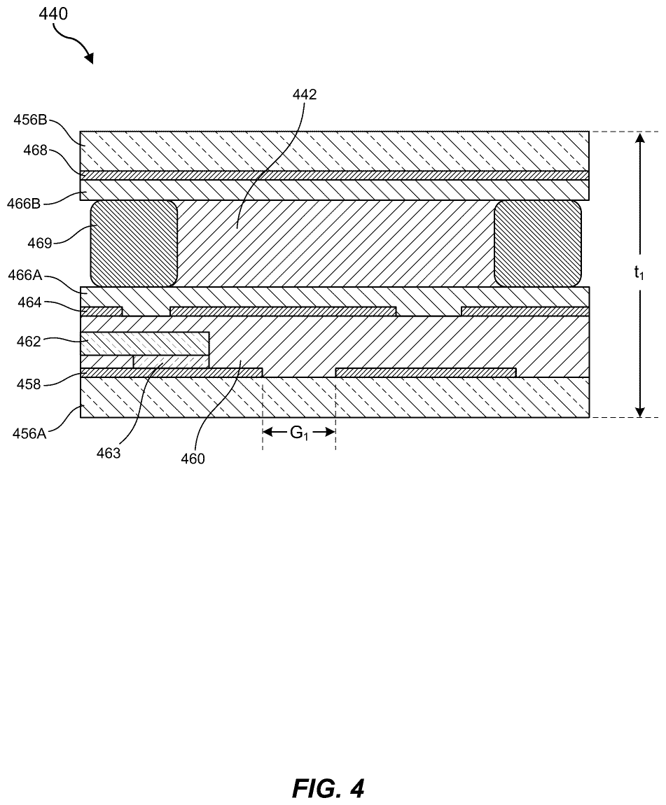

FIG. 3 shows a diagram 300 of light refracted through an example GRIN LC lens 340 according to some embodiments. Liquid crystal orientations may be varied as desired between liquid crystal molecules located at central and peripheral positions within GRIN LC lens 340. For example, liquid crystal molecules may be selectively oriented so as to redirect incident light to provide a desired degree of optical power. GRIN LC lens 340 in FIG. 3 includes a liquid crystal layer 342 that includes a solution of liquid crystal molecules 344. As shown, liquid crystal molecules 344 may be selectively varied in orientation proceeding from a central region to a laterally peripheral region of liquid crystal layer 342. For example, liquid crystal molecules 344 at a central region of liquid crystal layer 342 may be oriented substantially horizontal to surfaces abutting liquid crystal layer 342 (see, e.g., alignment layers 466A and 466B shown in FIG. 4). Proceeding peripherally outward from the center, liquid crystal molecules 344 may progressively change in pitch, with liquid crystal molecules 344 assuming an increasingly angular slope.

The orientations of liquid crystal molecules 344 in each region of liquid crystal layer 342 may be oriented by, for example, progressively changing a voltage applied to liquid crystal layer 342 at the respective regions. For example, a voltage applied to the peripheral region of liquid crystal layer 342 may be higher or lower than a voltage applied to the central region of liquid crystal layer 342, with voltages between the central and peripheral regions progressively increasing or decreasing proceeding from the central region to the peripheral region. While rod-shaped liquid crystal molecules are illustrated in the example shown in FIG. 3, any suitable liquid crystal molecules having any suitable shape may be included in liquid crystal layer 342. For example, liquid crystal layer 342 may additionally or alternatively include disc-like (i.e., discotic), bowlic (i.e., conic), bent-core, and/or any other suitable type of liquid crystal molecules.

FIG. 3 illustrates the manner in which variations in liquid crystal orientation may alter paths of light beams passing through liquid crystal layer 342. In the example shown, incident light beams may be refracted through various regions of liquid crystal layer 342 so that they are focused at a common focal point F1. In some embodiments, liquid crystal molecules 344 in liquid crystal layer 342 may be oriented to instead refract light outward to provide divergent lensing. In the example illustrated in FIG. 3, incident light 346 may approach an incident side surface 343 of GRIN LC lens 340 along an incident wavefront 350 such that incident light 346 enters GRIN LC lens 340 at an angle that is approximately normal to incident side surface 343. As described in greater detail below with reference to FIG. 4, external side surfaces of liquid crystal layer 342 may include transparent surfaces, such as surfaces formed of glass, polymer, sapphire, silicon-based materials, etc., which may be uncoated or coated (e.g., with an antireflective film).

Incident light 346 may pass through liquid crystal layer 342, where the light is refracted by liquid crystal molecules 344. Liquid crystal molecules 344 in different regions of liquid crystal layer 342 may be oriented at varied angles so as to refract light at correspondingly different angles within each region. For example, as shown in FIG. 3, liquid crystal molecules 344 may vary in degree of inclination with respect to abutting surfaces (e.g., alignment surfaces as shown in FIG. 4) along a gradient proceeding from the central region towards the outer periphery of liquid crystal layer 342. Liquid crystal molecules 344 having higher degrees of inclination may refract incoming light to a greater extent than those with lower degrees of inclination, as represented by liquid crystal wavefronts 352, which have different orientations corresponding to different inclinations of liquid crystal molecules 344 at various locations. The liquid crystal molecules 344 may thus be oriented at pitches that direct light in different regions towards a common focal point. Beams of exiting light 348 emitted from an exit side surface 345 of GRIN LC lens 340 are shown in FIG. 3. The exiting light 348 at different regions may be directed along corresponding exiting wavefronts 354 such that beams of exiting light 348 converge at an exemplary focal point F1.

In some examples, different voltage profiles may be applied to liquid crystal layer 342 to change optical characteristics of GRIN LC lens 340 as needed. For example, voltages may be selectively applied by an electrode array of GRIN LC lens 340 to reorient liquid crystal molecules 344 so as to change the location of focal point F1 and an optical power of GRIN LC lens 340. In at least one embodiment, liquid crystal molecules 344 may also be selectively oriented to produce a negative diopter in GRIN LC lens 340 so as to spread incoming light outward in a manner similar to a concave lens. In this example, the negative power may be accomplished by orienting liquid crystal molecules 344 within various regions of liquid crystal layer 342 to refract light outward to an increasingly greater extent proceeding from a central region outward toward the periphery.

FIG. 4 is a cross-sectional diagram illustrating the structure of an example GRIN LC lens 440 according to some embodiments. Dimensions of GRIN LC lens 440 and/or parts thereof illustrated in this figure are not necessarily to scale. As shown, GRIN LC lens 440 may include a pair of lens substrates 456A and 456B defining opposing outer surfaces of GRIN LC lens 440. Lens substrates 456A and/or 456B may be formed of one or more rigid, transparent materials, such as glass, sapphire, polymer, and/or silicon-based (e.g., SiO₂) materials. Lens substrates 456A and 456B may be substantially transparent in the visible wavelength band (i.e., approximately 380 nm to approximately 750 nm). In certain embodiments, the lens substrate 456A and/or 456B may also be transparent in some or all of the infrared (IR) band (i.e., approximately 750 nm to approximately 1 mm). Surfaces of lens substrates 456A and 456B may be uncoated or coated (e.g., with an antireflective film, polarization film, etc.). GRIN LC lens 440 may have a lens thickness t₁ measured from lens substrate 456A to lens substrate 456B.

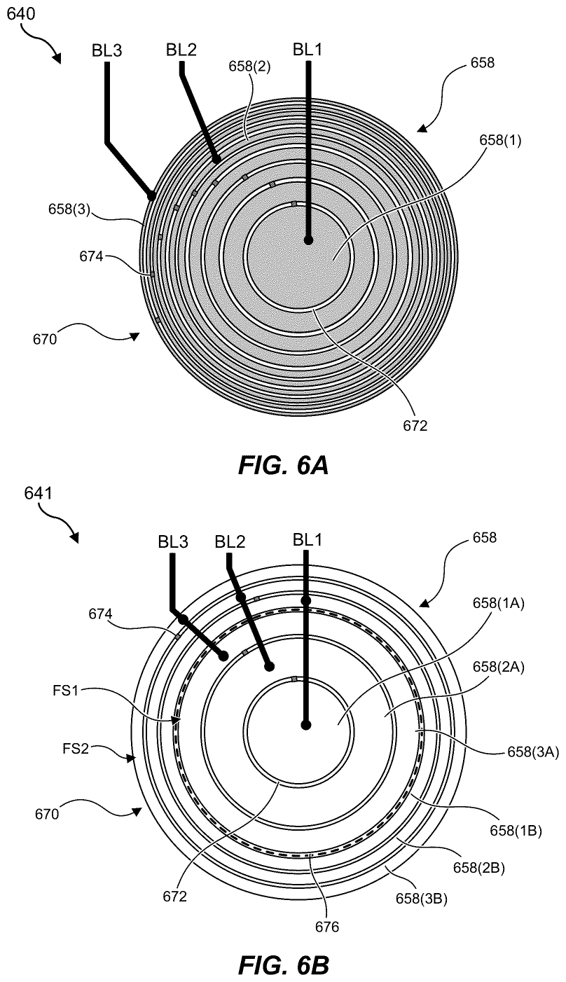

As shown in FIG. 4, and array of driving electrodes 458 may be disposed on a first lens substrate 456A. Adjacent driving electrodes 458 may be separated from each other by intervening gaps G₁, as illustrated. Gaps G₁ may each have any suitable width between driving electrodes 458, such as a width of from approximately 0.5 μm to approximately 4 μm (e.g., approximately 0.5, 1.0, 1.5, 2.0, 2.5, 3.0, 3.5, or 4.0 μm). As described in additional detail below, adjacent driving electrodes 458 may be electrically coupled to each other by a linking resistor within a shared driving zone (see, e.g., FIGS. 6A and 6B). Driving electrodes 458 may be arranged in a driving electrode array that overlaps a liquid crystal layer 442 of GRIN LC lens 440.

A bus line 462 may be electrically coupled to at least one of driving electrodes 458 to provide selected voltages to driving electrodes 458. For example, bus line 462 may be electrically coupled to the illustrated driving electrode 458 by a via interconnect 463 extending directly between bus line 462 and the driving electrode 458. Voltages at other driving electrodes 458 may be different than the voltage applied by bus line 462 due to, for example, reductions in voltages across the inter-electrode resistors connecting other driving electrodes to the driving electrode 458 coupled to the bus line 462. Voltages applied to each of driving electrodes 458 may be controllably varied to produce desired lensing of light passing through liquid crystal layer 442. In various examples, GRIN LC lens 440 may include multiple bus lines that are each electrically coupled to different electrodes to provide separate driving zones and/or Fresnel reset regions, as discussed in more detail below. Additionally, multiple bus lines within a particular driving zone and/or Fresnel reset may be used to apply different voltages to separate driving electrodes 458 so as to provide a voltage gradient(s) between the driving electrodes 458.

According to at least one embodiment, an insulating layer 460 may be disposed over driving electrodes 458 and bus line 462. Insulating layer 460 may also surround portions of bus line 462 not directly coupled to a driving electrode 458 such that portions of insulating layer 460 are disposed between bus line 462 and other driving electrodes 458. In some examples, portions of insulating layer 460 may also be disposed in gaps G₁ defined between adjacent driving electrodes 458. Insulating layer 460 may include one or more dielectric layers, which may include a stoichiometric or non-stoichiometric oxide, fluoride, oxyfluoride, nitride, oxynitride, sulfide, SiO₂, TiO₂, Al₂O₃, Y₂O₃, HfO₂, ZrO₂, Ta₂O₅, Cr₂O₃, AlF₃, MgFS₂, NdF₃, LaF₃, YF₃, CeF₃, YbF₃, Si₃N₄, ZnS, and/or ZnSe.

A floating electrode array including a plurality of floating electrodes 464 may be disposed on insulating layer 460 so that insulating layer 460 is disposed between driving electrodes 458/bus line 462 and floating electrodes 464. As shown in FIG. 4, floating electrodes 464 may be arrayed so as to overlap gaps G₁ between driving electrodes 458. Floating electrodes 464 may be capacitively coupled to driving electrodes 458 rather than directly driven by ohmic connection to driving electrodes 458. In some examples, floating electrodes 464 may be configured to cover a portion of the area of each of neighboring driving electrode 458 (e.g., up to approximately half of each neighboring driving electrode 458). In some examples floating electrodes 464 may be configured to overlap a substantial portion (e.g., approximately half or less) of the area of each neighboring driving electrode 458. Floating electrodes 464 may address image degradation in GRIN LC lens 440 by reducing light scattering due to gaps G₁ defined between adjacent driving electrodes 458.

A first alignment layer 466A may be formed over floating electrodes 464 and portions of insulating layer 460 exposed in gap regions between adjacent floating electrodes 464. First alignment layer 466A may contact liquid crystal layer 442 and may enable proper orientation of liquid crystal molecules within liquid crystal layer 442. First alignment layer 466A may include any material and surface texture suitable for aligning liquid crystal molecules in a desired manner. For example, first alignment layer 466A may be formed of a polyimide (PI) material that is rubbed on the surface facing liquid crystal layer 442. In at least one example, first alignment layer 466A may be formed of a PI layer having a surface that is modified by irradiation with ultraviolet (UV) light to promote curing or partial curing of the PI material. Following UV irradiation, the surface of first alignment layer 466A may be mechanically rubbed in selected directions (e.g., horizontally, circularly, etc.) to provide a substantially consistent surface structure producing predictable surface alignment of liquid crystal molecules in liquid crystal layer 442. Any other suitable material or combination of materials may be included in first alignment layer 466A, including, for example, polymers (e.g., perfluoropolyether films), metal-oxides, and/or carbon nanotubes.

GRIN LC lens 440 may also include a second alignment layer 466B facing first alignment layer 466A. In some embodiments, second alignment layer 466B may be formed in the same or similar manner as first alignment layer 466A and may include the same or similar materials (e.g., PI). Additionally or alternatively, second alignment layer 466B may include any other suitable materials formed using any suitable technique providing a surface configured to adequately align liquid crystal molecules within liquid crystal layer 442 in combination with first alignment layer 466A.

Liquid crystal layer 442 may be disposed between first and second alignment layers 466A and 466B, as illustrated in FIG. 4. Additionally, a gasket 469 may be disposed between first and second alignment layers 466A and 466B and may at least partially surround an outer periphery of liquid crystal layer 442. In some examples, gasket 469 may include spacers to maintain a selected space (i.e., LC cell space) between first and second alignment layers 466A and 466B such that liquid crystal layer 442 has a cell thickness suitable for proper operation, as described herein. Additional spacers may be included as needed between first and second alignment layers 466A and 466B to maintain a consistent space between the layers. Gasket 469 may provide an edge seal around liquid crystal layer 442 and may include any suitable adhesive and/or sealing agent to prevent leakage at the periphery.

In various embodiments, GRIN LC lens 440 may additionally include at least one common electrode 468 disposed between second alignment layer 466B and second lens substrate 456B. In one example, common electrode 468 may be formed as a unitary layer overlapping all or substantially all of liquid crystal layer 442, driving electrodes 458, and floating electrodes 464. In certain examples, GRIN LC lens 440 may include multiple common electrodes 468 that together cover or substantially cover liquid crystal layer 442. An electric field may be generated between common electrode 468 and driving electrodes 458 and/or floating electrodes 464 when selected voltages are applied to common electrode 468 and driving electrodes 458. In various examples, common electrode 468 may be held at a single selected voltage and, in combination with driving electrodes 458 and/or floating electrodes 464, may enable a range of voltage differentials to be selectively applied to regions of liquid crystal layer 442. Accordingly, driving electrodes 458 may, in combination with common electrode 468, generate variable electric fields that reorient liquid crystal molecules in liquid crystal layer 442 to produce a desired lens phase profile.

Driving electrodes 458, floating electrodes 464, common electrode 468, and bus line 462 may include one or more electrically conductive materials, such as a semiconductor (e.g., a doped semiconductor), metal, carbon nanotube, graphene, oxidized graphene, fluorinated graphene, hydrogenated graphene, other graphene derivatives, carbon black, transparent conductive oxides (TCOs, e.g., indium tin oxide (ITO), zinc oxide (ZnO), indium gallium zinc oxide (IGZO), etc.), conducting polymers (e.g., PEDOT), and/or other electrically conductive material. In some embodiments, the electrodes may include a metal such as nickel, aluminum, gold, silver, platinum, palladium, tantalum, tin, copper, indium, gallium, zinc, alloys thereof, and the like. Further example transparent conductive oxides include, without limitation, aluminum-doped zinc oxide, fluorine-doped tin oxide, indium-doped cadmium oxide, indium zinc oxide, indium zinc tin oxide, indium gallium tin oxide, indium gallium zinc oxide, indium gallium zinc tin oxide, strontium vanadate, strontium niobate, strontium molybdate, and calcium molybdate. In some examples, the electrodes and/or bus line may each include one or more layers, grids, nanowires, etc. of any suitable transparent conductive material, such as transparent conductive oxides, graphene, etc. Driving electrodes 458, floating electrodes 464, common electrode 468, and/or bus line 462 may have an optical transmissivity of at least approximately 50% (e.g., approximately 50%, approximately 60%, approximately 70%, approximately 80%, approximately 90%, approximately 95%, approximately 97%, approximately 98%, approximately 99%, or approximately 99.5%, including ranges between any of the foregoing values).

Electrode patterns for GRIN LC lenses, as disclosed herein, may be configured to produce desired lens profiles when operated. For example, modeling may be utilized to determine and/or optimize various design parameters, such as the shapes of the electrodes, the number of driving electrodes, the number of Fresnel reset regions, the types of resistors coupling adjacent electrodes, and/or the number of bus lines utilized to produce adequate lens shapes and provide a sufficient range of lens power while minimizing visual aberrations and delays in response time that might be perceptible to a wearer.

A “director,” as used herein, may refer to an axis oriented in an average direction of long molecular axes of all liquid crystal molecules in a liquid crystal bulk or selected region thereof. Individual liquid crystal molecules may be more or less aligned with this directional axis. Accordingly, liquid crystal molecules, such as rod-like liquid crystal molecules, may be generally oriented such that their moments of inertia are roughly aligned along the director.

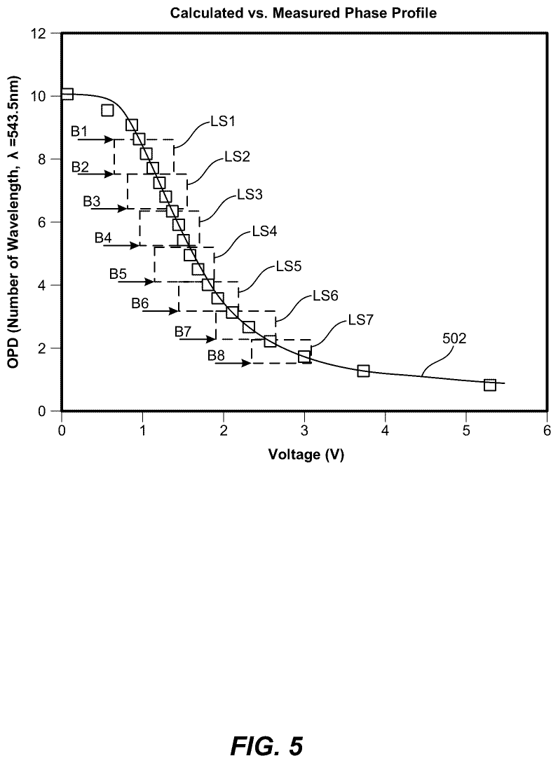

FIG. 5 is a plot illustrating a curve of optical path difference (OPD) versus voltage that may be utilized in director modeling to optimize certain design parameters of a GRIN LC lens as disclosed herein. In some embodiments, a liquid crystal relaxation method may be used to numerically calculate a director configuration at equilibrium. In this method, the calculation for the director configuration may be determined by minimizing the free energy for a given set of boundary conditions and external fields. This calculation may then be utilized to obtain the desired phase profile.

A GRIN LC lens design may include concentric ring-shaped electrodes (see, e.g., FIGS. 6A and 6B) with substantially identical areas to produce a parabolic phase profile or other suitable aspheric phase profile (e.g., elliptical, hyperbolic, etc.). With this electrode geometry, a parabolic phase may be obtained when the phase difference between adjacent electrodes is approximately the same. If the phase is proportional to the applied voltage, a linear change in the voltage across the electrodes (i.e., with approximately the same difference in voltage between any two electrodes) would yield a parabolic phase profile. To impose a linear voltage drop over several electrodes, inter-ring resistors can be utilized. The resistors between electrodes may act as voltage dividers. If the phase vs. voltage curve were in general linear, only two interconnections would be required to drive the lens. Additional resistive interconnections are utilized, however, to provide a curved phase profile, with more than three interconnections enabling a parabolic phase profile.

In various embodiments, the slope of optical path difference (OPD) vs. voltage curve 502 of a liquid crystal material, as disclosed herein, may not remain constant but may rather become substantially steeper at regions corresponding to lower voltage values. In at least one example, the nonlinearity of OPD vs. voltage curve 502 may be addressed by segmenting curve 502 into a number of different linear sections that together may better approximate the profile of curve 502 in a manner that has little or no impact on perceptible optical characteristics of the resulting GRIN LC lens. As shown in FIG. 5, curve 502 is broken up into a number of linear sections LS1-LS7 (boxes surround the relevant sections of curve 502 for ease of illustration). When utilizing resistors of approximately the same value between neighboring driving electrodes, in accordance with various embodiments, voltages in each region may be reliably defined by connections to a programmable voltage source at end points of linear segments LS1-LS7 shown in FIG. 5.

While seven linear sections are shown in the illustrated example, curve 502 may be segregated into any other suitable number of linear sections. The number of linear sections may determine the number of interconnections and bus lines required to drive the GRIN LC lens. In the example illustrated in FIG. 5, eight bus lines B1-B8, which are each supplied with a different voltage, are used to obtain linear voltage drops at linear sections LS1-LS7. Bus lines B1-B8 are shown at positions on curve 502 corresponding to voltage values that would be respectively applied to each of bus lines B1-B8. Each linear section has a linear drop in voltage between a driving electrode directly coupled to a higher voltage bus line and a driving electrode directly coupled to a lower voltage bus line. Resistors separating neighboring driving electrodes between the driving electrodes directly coupled to the bus lines may maintain a consistent voltage drop between the neighboring driving electrodes.

FIG. 6A illustrates a GRIN LC lens 640 that includes a driving electrode array 670 according to some embodiments. The illustrated driving electrode array 670 may represent a simplified patterned array presented for purposes of illustration, and various exemplary electrode arrays may include a greater number of driving electrodes and bus lines. As shown, driving electrode array 670 includes a plurality of driving electrodes 658 that are arranged in concentric rings surrounding a central, circular driving electrode 658(1). The areas covered by each of the plurality of driving electrodes 658 (i.e., the areas overlapping a corresponding liquid crystal layer) may be approximately the same. Hence, driving electrodes 658, most of which have a ring-shaped profile following an arcuate path (e.g., a circular path), may decrease in width as the electrode circumferences increase, proceeding from central driving electrode 658(1) outward. As shown, driving electrode array 670 may have a circular shape configured to overlap a circular-shaped liquid lens layer having approximately the same shape and dimensions. However, in some embodiments, driving electrode array 670 and GRIN LC lens 640 may have any other suitable profile shape, including a noncircular shape.

As shown in FIG. 6A, neighboring driving electrodes 658 are separated by ring-shaped gap regions 672 (see gap G₁ in FIG. 4). Gap regions 672 may have widths of, for example, from approximately 0.5 μm to approximately 5 μm. Additionally, a separate resistor 674 may connect each pair of neighboring driving electrodes 658. The resistors 674 may enable each driving electrode 658 to be maintained at a different voltage when different voltages are applied via bus lines to two or more of driving electrodes 658. In some examples, consecutive resistors 674 may be located at different angular positions along driving electrode array 670. For example, neighboring resistors 674 may be separated by angular distances of from approximately 1° to approximately 10° or more.

In the example of FIG. 6A, three example bus lines BL1, BL2, and BL3 are illustrated. Bus lines BL1, BL2, and BL3 are each electrically coupled (i.e., directly coupled, connected, or otherwise attached electrically) to a different driving electrode 658. In the illustrated example, bus line BL1 is electrically coupled to the center-most driving electrode 658(1) and bus line BL3 is electrically coupled to a driving electrode 658(3) located at a more peripheral position. Bus line BL2 is electrically coupled to a driving electrode 658(2) disposed between driving electrodes 658(1) and 658(3) (i.e., between the center and outer periphery of driving electrode array 670). The plurality of driving electrodes 658 may produce a varying electric field in conjunction with one or more common lines disposed on an opposite side of an overlapping liquid crystal layer (see, e.g., common electrode 468 disposed on a side of liquid crystal layer 442 opposite driving electrodes 458, as shown in FIG. 4). The electric field generated between driving electrodes 658 and the overlapping common electrode(s) may produce selected alignments of liquid crystal molecules in the liquid crystal layer. In some embodiments, the common electrode(s) may be maintained at a particular voltage value, and variations in liquid crystal alignments may correspond to different voltages of overlapping driving electrodes 658.

In at least one example, a first voltage may be applied by bus line BL1 to driving electrode 658(1) and a lower or higher voltage may be applied by bus line BL3 to driving electrode 658(3). A voltage having a value between that of bus lines BL1 and BL3 may be applied by bus line BL2 to driving electrode 658(2). In some examples, voltages of driving electrodes 658 may decrease or increase linearly or substantially linearly between pairs of bus lines (see, e.g., linear sections LS1-LS7 between pairs of bus lines B1-B8 shown in FIG. 5). This may be accomplished by, for example, providing resistors 674 that have substantially the same value between each pair of neighboring driving electrodes 658. Accordingly, voltage drops between neighboring driving electrodes 658 located between two bus lines (e.g., between bus lines BL1 and BL2 and/or between bus lines BL2 and BL3) may be relatively consistent.

In at least one embodiment, amounts of voltage drop or increase between adjacent driving electrodes 658 and/or between neighboring bus lines may be substantially constant. Because the radial width of driving electrodes 658 progressively decreases proceeding from the center of driving electrode array 670 outward, the voltage changes may likewise change at progressively smaller intervals proceeding radially outward. The decreasing radial intervals between driving electrodes 658 may result in progressively greater changes in liquid crystal orientation proceeding radially outward along the GRIN LC lens so that a selected lens curvature (e.g., a spherical curvature) is applied to light passing through the GRIN LC lens. For example, in one embodiment, bus line BL1 may apply approximately 4 V to the center-most driving electrode 658(1) and bus line BL3 may apply approximately 0 V to the outer-most driving electrode 658(3). In this example, bus line BL2 may apply approximately 2 V to driving electrode 658(2), which is disposed at a location between driving electrodes 658(1) and 658(3). Driving electrode 658(2) may be located such that the number of driving electrodes 658 located between driving electrodes 658(1) and 658(2) is the same or nearly the same as the number of driving electrodes 658 located between driving electrodes 658(2) and 658(3). Any other suitable number, distribution, and/or configuration of driving electrodes 658 may be utilized in various examples.

In some embodiments, voltage drops between different pairs of bus lines may have different slopes so as to produce a desired lens profile in the GRIN LC lens. Any suitable combination of voltage values may be applied to bus line BL1-BL3 to produce selected electrical field gradients in an overlapping liquid crystal layer. For example, a total voltage drop between bus lines BL2 and BL3 may be more or less steep than a total voltage drop between bus lines BL1 and BL2.

FIG. 6B illustrates a GRIN LC lens 641 that includes a driving electrode array 670, in accordance with some embodiments. The illustrated driving electrode array 670 may represent a simplified array and Fresnel layout presented for purposes of illustration, and various exemplary electrode arrays may include a greater number of driving electrodes, bus lines, and/or Fresnel reset sections. As shown, driving electrode array 670 includes a plurality of driving electrodes 658 that are arranged in concentric rings. As shown, driving electrode array 670 may have a circular shape configured to overlap a circular-shaped liquid lens layer having approximately the same shape and dimensions. However, in some embodiments, driving electrode array 670 and GRIN LC lens 641 may have any other suitable profile shape, including a noncircular shape.

Driving electrode array 670 may be divided into a plurality of Fresnel reset sections. In the example shown in FIG. 6B, driving electrode array 670 is divided into first and second Fresnel reset sections FS1 and FS2. Fresnel reset sections FS1 and FS2 may be utilized to generate Fresnel resets in a phase profile of GRIN LC lens 641, as discussed in greater detail below. Neighboring driving electrodes 658 may be separated by ring-shaped gap regions 672 and resistors 674 may connect pairs of neighboring driving electrodes 658 within each of Fresnel reset sections FS1 and FS2. An intermediate gap 676 may be defined between Fresnel reset sections FS1 and FS2. Unlike gap regions 672 disposed between adjacent driving electrodes 658 within each Fresnel reset section, electrodes in Fresnel reset sections FS1 and FS2 adjacent to intermediate gap 676 may not be electrically connected to each other via a resistor or other connector bridging the electrodes across intermediate gap 676. Accordingly, first and second Fresnel reset sections FS1 and FS2 may produce distinct voltage gradients in independently operable lens regions in GRIN LC lens 641.

In the embodiment of FIG. 6B, three example bus lines BL1, BL2, and BL3 are illustrated. Bus lines BL1, BL2, and BL3 are each electrically coupled (i.e., directly coupled, connected, or attached electrically) to a different respective driving electrode 658 in each of first and second Fresnel reset sections FS1 and FS2. In the illustrated example, bus line BL1 is electrically coupled to each of driving electrodes 658(1A) and 658(1B), bus line BL2 is electrically coupled to each of driving electrodes 658(2A) and 658(2B), and bus line BL3 is electrically coupled to each of driving electrodes 658(3A) and 658(3B) located respectively within each of Fresnel reset sections FS1 and FS2. In at least one example, a first voltage may be applied by bus line BL1 to driving electrodes 658(1A) and 658(1B) and a lower or higher voltage may be applied by bus line BL3 to driving electrodes 658(3A) and 658(3B). A voltage having a value between that of bus lines BL1 and BL3 may be applied by bus line BL2 to driving electrodes 658(2A) and 658(2B).

Driving electrode array 670 may be utilized to provide GRIN LC lens 641 with a segregated Fresnel structure. The GRIN LC lens may include any appropriate type of Fresnel structure, such as a Fresnel zone plate lens including areas that have a phase difference of a half-wave to adjacent areas, a diffractive Fresnel lens having a segmented parabolic phase profile where the segments are small and can result in significant diffraction, or a refractive Fresnel lens having a segmented parabolic profile where the segments are large enough so that diffraction effects are minimized. Other structures may also be used.

In some embodiments, the driving electrode array 670 may be utilized in a refractive Fresnel GRIN LC lens having a segmented parabolic profile, where the segments are large enough that the resulting diffraction angle is smaller than the angular resolution of human eyes (i.e., diffraction effects are not observable by human eyes). Such a refractive Fresnel LC lens may be referred to as a segmented phase profile (SPP) LC lens.

For a positive thin lens, optical path difference (OPD) can be approximated with a Maclaurin series to a parabolic profile as shown in Equation (1)

$$OPD ( r ) = \frac{{r}^{2}}{2 f} , \qquad ( 1 )$$

where r is the lens radius (i.e., half of the lens aperture) and f is the focal length. The OPD of an LC lens is proportional to the cell thickness d and the birefringence Δn of the LC material as shown in Equation (2)

$$OPD = Δ n \times d \to d ∝ {r}^{2} \qquad ( 2 )$$

The response time t of an Electrically Controlled Birefringence (ECB) LC cell, which is the time the material requires to recover to its original state, is quadratically dependent on cell thickness d (τ ∝ r⁴) as shown in Equation (3)

$$τ = \frac{( γ \times {d}^{2} )}{( {K}_{22} \times {π}^{2} )} , \qquad ( 3 )$$

where γ and K₂₂ are the rotational viscosity and the splay elastic constant of the LC material, respectively. As equations (1)-(3) show, there is typically a tradeoff between the aperture size and response time. Thus, designing a GRIN LC lens with large aperture and reasonable response time has conventionally presented challenges. In the disclosed embodiments, by introducing phase resets (i.e., Fresnel resets) in the parabolic phase profile, the aperture size of the LC lens may be increased without compromising the response time.

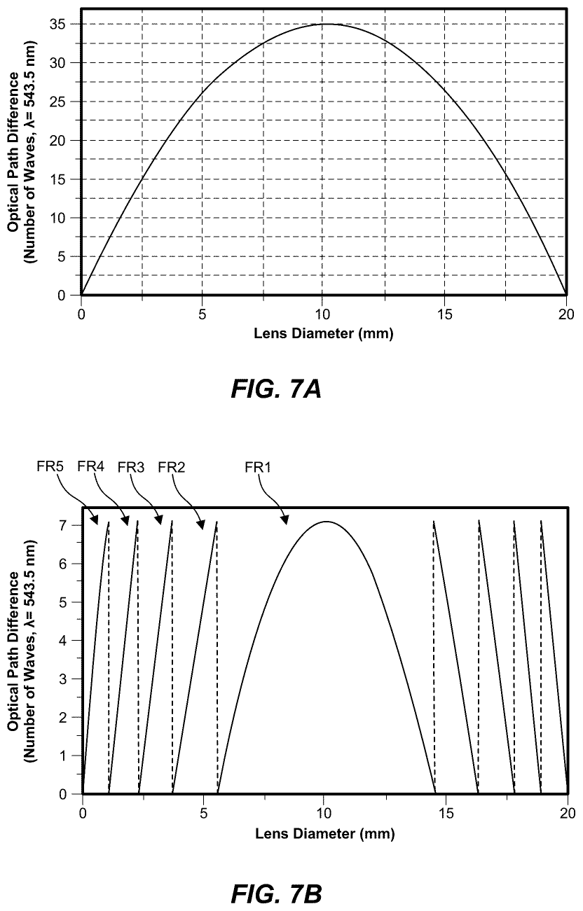

FIG. 7A illustrates an exemplary target parabolic phase profile for a ±0.375 Diopter (D) GRIN LC lens having a lens diameter of 20 mm, where the OPD equals to 35 λ. The thickness of the LC cell for this lens would be approximately 70 μm for LC materials having a birefringence value of 0.27. To decrease the effective thickness of the LC cell, Fresnel resets or segments may be introduced into the lens phase profile.

FIG. 7B illustrates a phase map of an exemplary GRIN LC lens having five Fresnel resets FR1-FR5 that together approximate the lens characteristics of the idealized phase profile of FIG. 7A. As shown, the centermost Fresnel reset FR1 may occupy a wide area surrounding the center of the GRIN LC lens. Additional Fresnel resets FR2-FR5 surrounding central Fresnel reset FR1 may have thicknesses that are sequentially reduced proceeding peripherally outward toward the lens periphery. For example, Fresnel reset FR2 may be radially thinner than Fresnel reset FR1. Additionally, Fresnel reset FR3 may be radially thinner than Fresnel reset FR2, Fresnel reset FR4 may be radially thinner than Fresnel reset FR3, and Fresnel reset FR5 may be radially thinner than Fresnel reset FR4. The phase profiles of each of Fresnel resets FR1-FR5 may likewise increase in conjunction with decreases in thickness of the resets. For example, Fresnel reset FR5 may have a steeper profile than Fresnel reset FR4, which has a steeper profile than Fresnel reset FR3. Fresnel reset FR3 may likewise have a steeper profile than Fresnel reset FR2, which has a steeper profile than central Fresnel reset FR1.

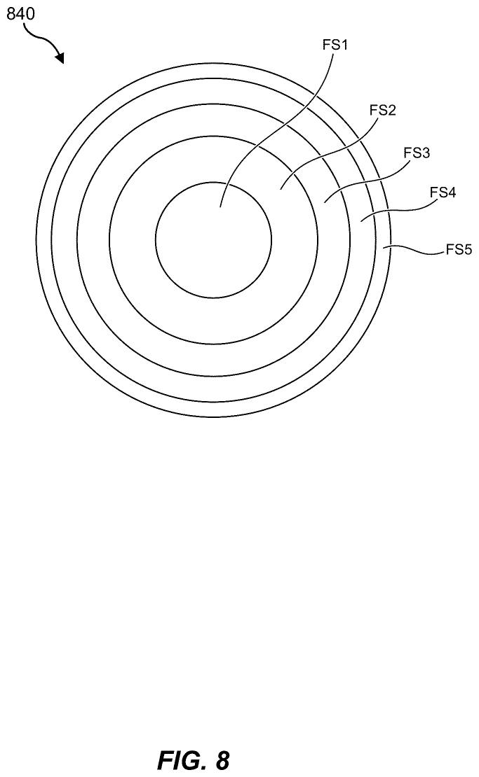

FIG. 8 illustrates an exemplary GRIN LC lens 840 that includes a plurality of concentric ring-shaped segments of increasing radii that are referred to as Fresnel reset sections. As shown in FIG. 8, GRIN LC lens 840 may have five Fresnel reset sections FS1-FS5 respectively corresponding to the five Fresnel resets FR1-FR5 mapped in FIG. 7B. As shown in FIG. 8, Fresnel reset section FS1 may be centrally located and Fresnel reset sections FS2-FS5 may concentrically surround Fresnel reset section FS1. For example, Fresnel reset section FS2 may circumferentially surround central Fresnel reset section FS1, Fresnel reset section FS3 may circumferentially surround Fresnel reset section FS2, Fresnel reset section FS4 may circumferentially surround Fresnel reset section FS3, and outermost Fresnel reset section FS5 may circumferentially surround Fresnel reset section FS4. In correspondence with variations in thicknesses of Fresnel resets FR1-FR5 as shown in FIG. 7B, FIG. 8 likewise shows that Fresnel reset sections FS1-FS5 may progressively decrease in radial thickness proceeding from the centermost Fresnel reset section FS1 outward.

The five Fresnel reset sections FS1-FS5 of GRIN LC lens 840 may enable the corresponding LC cell thickness of GRIN LC lens 840 to be reduced up to five times, resulting in an LC cell thickness as low as approximately 14 μm. Likewise, the response time of the illustrated GRIN LC lens may be improved by a factor of up to 25. That is, the introduction of the Fresnel resets in the GRIN LC lens phase profile may enable the optical power of GRIN LC lens 840 to be adjusted sufficiently fast to keep pace with human eye accommodation (e.g., accommodation may occur in approximately 300 ms) such that the vergence-accommodation conflict may be substantially or fully resolved. The number of Fresnel resets/segments in a particular lens may be determined based on specific configurations of the Fresnel structure and the GRIN LC lens requirements, such as the desired optical power, lens aperture, switching time, and/or image quality of the GRIN LC lens.

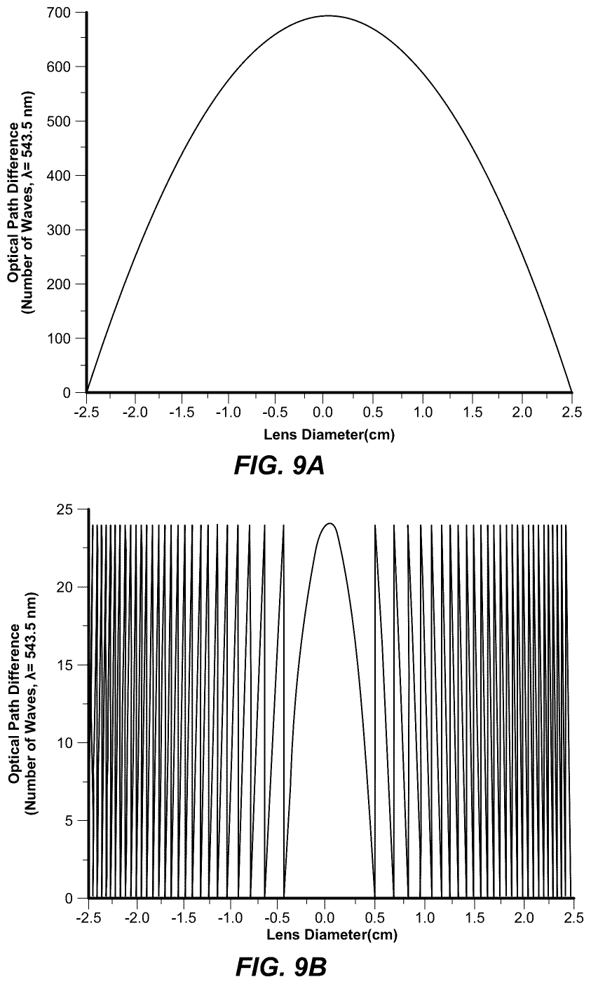

FIG. 9A illustrates an exemplary target parabolic phase profile for a GRIN LC lens having a greater width and focal range than that shown in FIG. 7A. For example, the GRIN LC lens mapped in FIG. 9A has a focal range of ±1.20 D, a lens diameter of 50 mm (5.0 cm), and an OPD that equals to approximately 700 λ for a green wavelength of approximately 543.5 nm.

FIG. 9B illustrates a phase map of an exemplary GRIN LC lens having a total of 28 Fresnel resets that together approximate the lens characteristics of the idealized phase profile of FIG. 9A. A large number of phase steps within one wavelength of OPD (i.e., a large number of phase steps per wavelength) may be desired to produce a more accurate representation of an idealized phase profile. The 28 Fresnel resets may enable a substantial reduction in the LC cell thickness and improvement in response time. To configure a GRIN LC lens with negligible diffraction angle for near eye applications, the minimum width of Fresnel reset sections of the GRIN LC lens may be selected to be larger than 1.03 mm. The resets may be formed in a single GRIN LC layer (e.g., a 60 μm thick layer) or distributed in multiple stacked GRIN LC layers (e.g., three stacked 20 μm thick layers). In some examples, GRIN LC layers may be stacked to further improve the response time of the overall GRIN LC lens. By way of example, a pair of optically coupled GRIN LC lens layers, with each layer having five resets in their phase profile, may enable the resulting LC cell thickness to be reduced up to 10 times (5 resets multiplied by 2 layers) and, accordingly, the response speed may be improved by a factor of approximately 100.

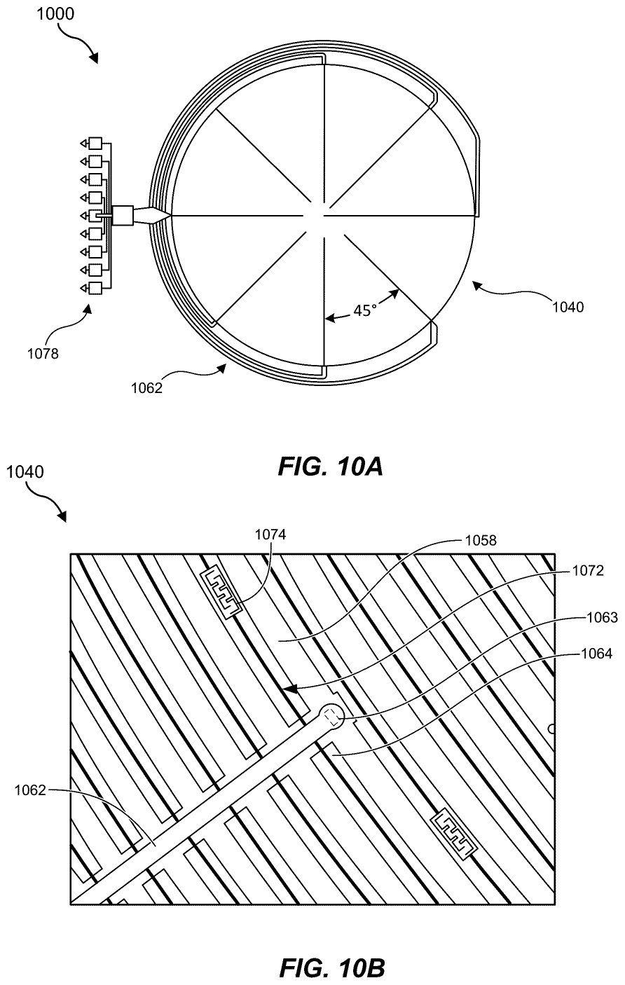

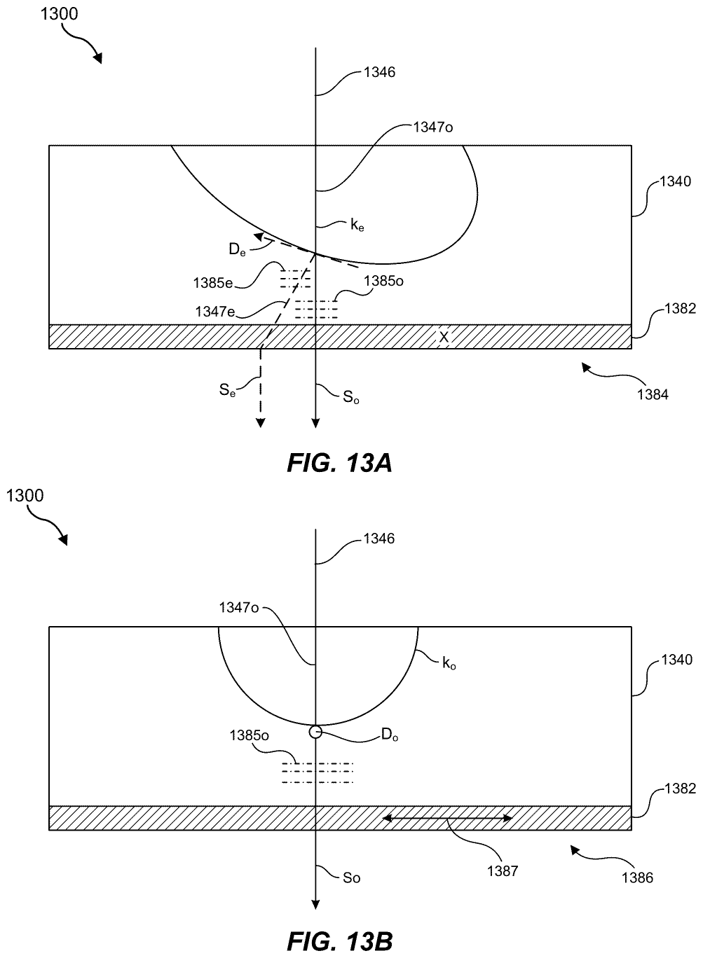

FIGS. 10A and 10B show a GRIN LC system 1000 and GRIN LC lens 1040 that includes an electrode array and bus lines according to various embodiments. As shown in FIG. 10A, GRIN LC system 1000 includes a plurality of bus lines 1062 that are electrically coupled to driving electrodes of GRIN LC lens 1040. For example, GRIN LC system 1000 may include eight bus lines 1062 as shown, with each of the eight bus 1062 lines being disposed at a different angular position about GRIN LC lens 1040. The bus lines 1062 may, for example, be evenly spaced apart from each other at regular angular intervals of approximately 45°, with each bus line extending from a peripheral position towards the center of GRIN LC lens 1040. Accordingly, portions of bus lines 1062 on GRIN LC lens 1040 may extend along radial lines located at angular positions of approximately 0°, 45°, 90°, 135°, 180°, 225°, 270°, and 315°. While GRIN LC lens 1040 shown in FIG. 10A has a substantially circular profile, GRIN LC lens 1040 may alternatively have any other suitable non-circular shape in various embodiments. Bus lines 1062 may extend between GRIN LC lens 1040 and terminals 1078, which may be connected to an external voltage source and controller (see, e.g., virtual reality engine 1345 in FIG. 13) that is configured to apply different voltages to terminals 1078 and corresponding bus lines 1062. Additionally, at least one of terminals 1078 may be coupled, via another bus line, to a common electrode (see, e.g., common electrode 468 in FIG. 4) and may apply a common voltage to the common electrode.

FIG. 10B shows a close-up view of a portion GRIN LC lens 1040 illustrated in FIG. 10A. As shown, GRIN LC lens 1040 may include a plurality of concentrically arranged driving electrodes 1058 that are separated from each other by gap regions 1072 (see, e.g., gap G₁ in FIG. 4; see also gap regions 672 in FIGS. 6A and 6B). Adjacent driving electrodes 1058 may be electrically coupled to each other by resisters 1074 that bridge the intervening gap regions 1072 to maintain a selected voltage drop(s) between the driving electrodes 1058. Additionally, concentrically arranged floating electrodes 1064 may be disposed over portions of driving electrodes 1058 so as to overlap gap regions 1072 disposed between adjacent driving electrodes 1058. A portion of a bus line 1062 coupled to one of the illustrated driving electrodes 1058 is shown in FIG. 10B. As shown, bus line 1062 is electrically coupled to a driving electrode 1058 by a via interconnect 1063 extending directly between bus line 1062 and the corresponding driving electrode 1058. Bus line 1062 shown in FIG. 10B may be separated from other driving electrodes 1058 by an insulating layer (see, e.g., insulating layer 460 in FIG. 4).

In some examples, each bus line 1062 may be coupled to a corresponding driving electrode 1058 within each of a plurality of Fresnel reset sections (see, e.g., Fresnel reset sections FS1 and FS2 in FIG. 6B; see also Fresnel reset sections FS1-FS5 in FIG. 8). For example, each bus line 1062 may extend from an outer periphery of the driving electrode array of GRIN LC lens 1040 towards a center of GRIN LC lens 1040. Accordingly, in this example, each bus line 1062 may cross over each of a plurality of concentric Fresnel reset sections. Via interconnects, such as via interconnect 1063 shown in FIG. 10B, may electrically couple each bus line 1062 to a corresponding driving electrode 1058 within each respective Fresnel reset section. Accordingly, the eight bus lines 1062 shown in FIG. 10A may be configured to simultaneously apply voltages to corresponding driving electrodes 1058 within each of a plurality of Fresnel reset sections.

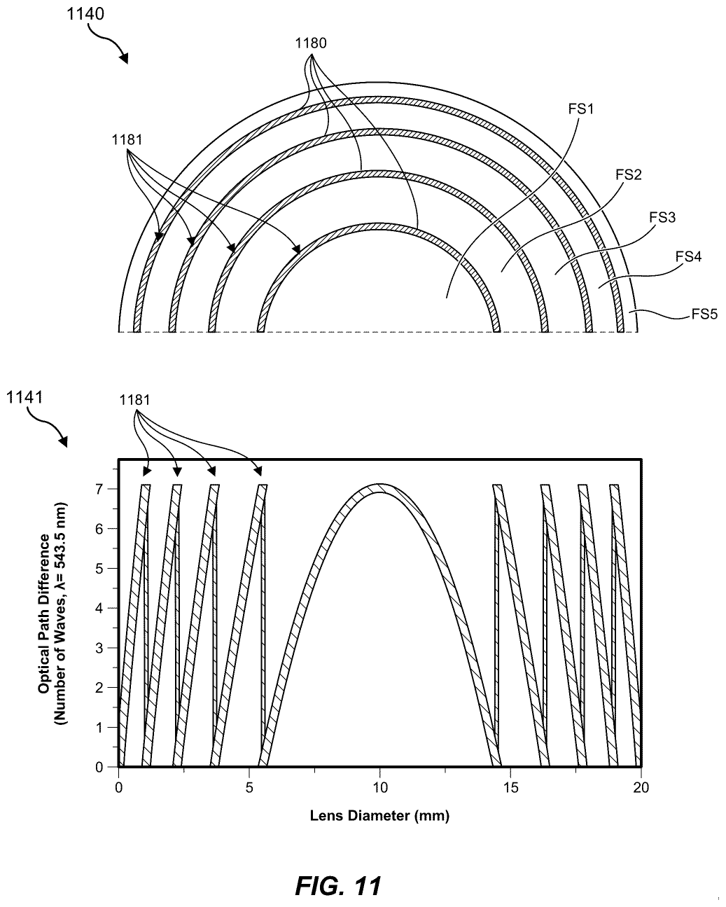

FIG. 11 illustrates a phase map 1141 of an exemplary GRIN LC lens having five Fresnel resets (see, e.g., FIG. 7B). Additionally, FIG. 11 illustrates a top view of a portion (i.e., a semicircular portion) of a GRIN LC lens 1140. For purposes of illustration, regions of the GRIN LC lens 1140 are sized and positioned to overlap corresponding regions of phase map 1141 in this figure.

Light-scattering regions 1180 of GRIN LC lens 1140 are illustrated in FIG. 11. Light-scattering regions 1180 may represent portions of GRIN LC lens 1140 where light is diffracted, reflected, diffused, and/or otherwise scattered in undesired directions. For example, light may be scattered by portions of GRIN LC lens 1140 in directions that are not aligned along specified wavefront(s) of GRIN LC lens 1140. Scattering of light may occur more heavily at and/or near transition regions 1181 located at junctions between adjacent Fresnel reset sections FS1-FS5. In some examples, voltages at transition regions 1181 may change abruptly and significantly between a higher and a lower voltage. The dramatic voltage discrepancies at transition regions 1181 may result in substantial variations in electric field and liquid crystal orientations at and/or near transition regions 1181, producing undesirable light scattering at these locations.

Light scattered from transition regions 1181 of GRIN LC lens 1140 may cause unpleasant image distortions and/or artifacts that a user may find visually objectionable. Light-scattering regions 1180 may overlap transition regions 1181 of GRIN LC lens 1140, with scattered light exiting from GRIN LC lens 1140 at or near transition regions 1181. In some examples, light-scattering regions 1180 may include portions of Fresnel reset sections FS1-FS5 located near transition regions 1181. For example, light may be scattered away from transition regions 1181 to neighboring regions. A leakage-reduction element, as discussed below, may block at least a portion of light scattered from light-scattering regions 1180. Additionally, in some embodiments, portions of the leakage-reduction element may act as a polarizer, blocking light from portions of GRIN LC lens 1140 that is not polarized in a desired manner.

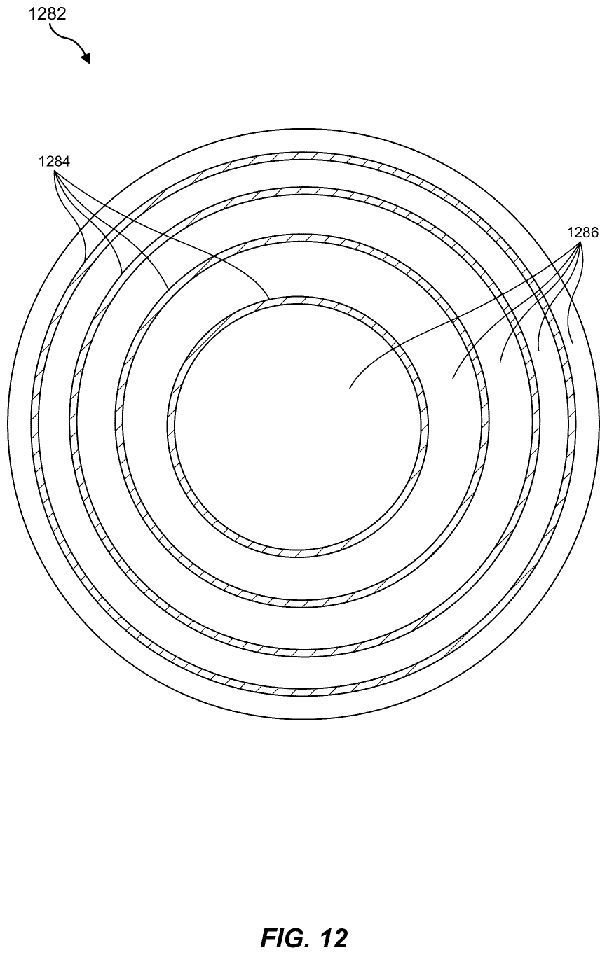

FIG. 12 illustrates an example leakage-reduction element 1282 of a GRIN LC system according to some embodiments. Leakage-reduction element 1282 may overlap a GRIN LC lens, such as GRIN LC lens 1140 shown in FIG. 11. According to various embodiments, leakage-reduction element 1282 may have a shape that conforms substantially to a shape of a corresponding GRIN LC lens. Accordingly, leakage-reduction element 1282 may overlap a GRIN LC lens so as to partially or substantially cover a field-of-view (FOV) of the GRIN LC lens. Leakage-reduction element 1282 may be coupled to the GRIN LC lens in any suitable manner. In some examples, leakage-reduction element 1282 may first be produced, after which it is subsequently laminated to a surface (e.g., a light exit surface) of the GRIN LC lens. Leakage-reduction element 1282 may include a plurality of light-blocking sections, with each of the light-blocking sections being one of at least two types. For example, as shown in FIG. 12, leakage-reduction element 1282 may include a set of first light-blocking sections 1284 alternating with a set of second light-blocking sections 1286.

In at least one example, first light-blocking sections 1284 may be positioned to overlap light-scattering regions of a GRIN LC (e.g., light-scattering regions 1180 of GRIN LC 1140 in FIG. 11). First light-blocking sections 1284 may be configured to block light scattered by the GRIN LC at and/or near transition regions between Fresnel reset sections (e.g., transition regions 1181 of Fresnel reset sections FS1-FS5, as shown in FIG. 11).

Second light-blocking sections 1286 may be disposed between and/or surrounding first light-blocking sections 1284 such that first and second light-blocking sections 1284 and 1286 are concentrically arranged as shown in FIG. 12. In at least one example, second-light-blocking sections 1286 may primarily overlap corresponding Fresnel reset sections of the GRIN LC (e.g., Fresnel reset sections FS1-FS5 of GRIN LC lenses 840 and 1140 in FIGS. 8 and 11). Second light-blocking sections 1286 may be configured, for example, to block light that is not polarized in a specified polarization direction.

FIGS. 13A and 13B are diagrams illustrating portions of an example GRIN LC system 1300 that includes a GRIN LC lens 1340 overlapping a leakage-reduction element 1382. As shown in these figures, incoming light 1346 passing through GRIN LC lens 1340 may be split into various rays traveling in different directions through GRIN LC lens 1340 such that the different light rays generated from incoming light 1346 exit GRIN LC lens 1340 and enter leakage-reduction element 1382 at different locations. For example, a beam of incoming light 1346 incident on a first surface of GRIN LC lens 1340 may be split into various rays, including an ordinary ray (O-ray) 1347o and an extraordinary ray (E-ray) 1347e. O-ray 13470 and E-ray 1347e may travel through GRIN LC lens 1340 at different velocities, with O-ray 13470 proceeding along O-ray wavefront 13850 and E-ray 1347e proceeding along E-ray wavefront 1385e.

In various examples, light may be scattered to a significant extent at certain regions of GRIN LC lens 1340, such as transition regions between Fresnel reset sections (see, e.g., transition regions 1181 in FIG. 11). The scattered light may proceed in directions not aligned along a desired wavefront of GRIN LC lens 1340. For example, the scattered light may be scattered in directions not aligned with O-ray wavefront 13850, such as the direction of E-ray 1347e traveling along E-ray wavefront 1385e as shown in FIG. 13A. While O-ray 13470 is illustrated following a path that is substantially perpendicular to surfaces of GRIN LC lens 1340 in FIGS. 13A and 13B, O-rays 13470 may alternatively follow paths that are obliquely angled with respect to various surface regions of GRIN LC lens 1340. For example, Fresnel regions of GRIN LC lens 1340 may redirect light in accordance with a selected lens power and shape. Additionally, light from a display or other light source may not be incident on an incoming surface of GRIN LC lens 1340.

In some embodiments, light passing through GRIN LC lens 1340, such as E-ray 1347e and O-ray 13470, may be incident on a portion of leakage-reduction element 1382, such as a surface of first light-blocking section 1384 or second light-blocking section 1386. E-ray 1347e and O-ray 13470 passing through first light-blocking section 1384 may be respectively directed along Poynting vectors Sₑ and Sₒ, as shown. According to at least one example, first light-blocking section 1384 may be configured to primarily block E-rays and second light-blocking section 1386 may be configured to primarily block O-rays (e.g., O-rays not having a selected polarization state).

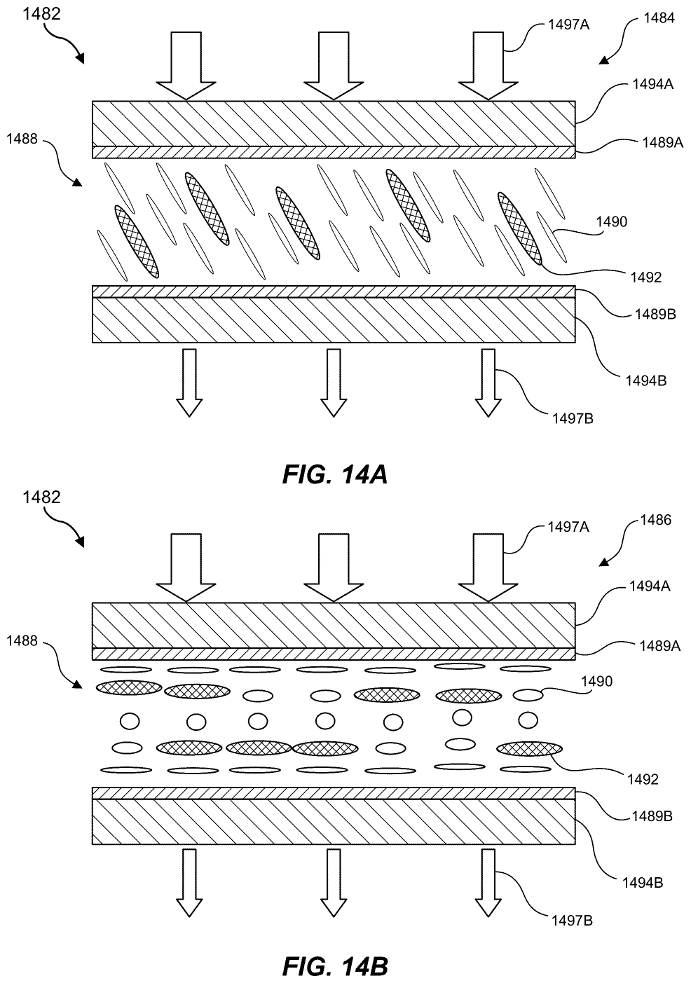

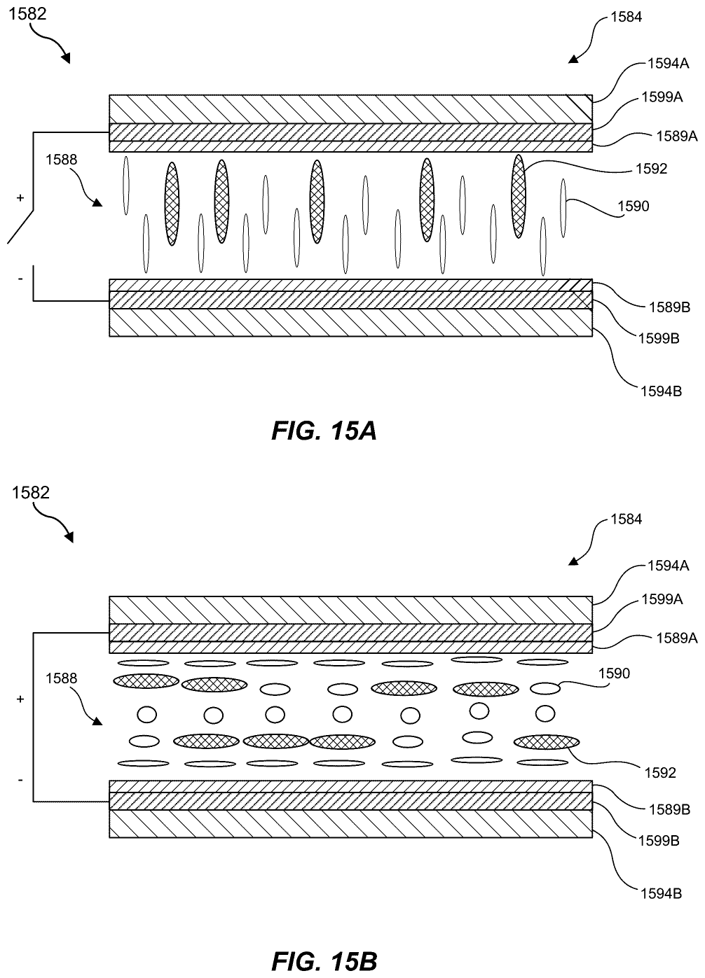

In some examples, leakage-reduction element 1382 may include a GHLC layer solution having liquid crystal molecules and interspersed dye molecules (see, e.g., FIGS. 14A-15B). Liquid crystal molecules in various regions of leakage-reduction element 1382 may be selectively oriented in accordance with a structured surface layer (e.g., an alignment layer) and/or an electric field applied to the regions. In various examples, liquid crystal molecules and dye molecules in first light-blocking section 1384 may be angled with respect to surfaces of leakage-reduction element 1382 and GRIN LC lens 1340. For example, the dye molecules may be obliquely and/or perpendicularly oriented with respect to light incident and/or light exit surfaces of leakage-reduction element 1382. In some examples, dye molecules in first light-blocking section 1384 may be oriented with their long axes extending along displacement field vector De shown in FIG. 13A.

According to some embodiments, FIG. 13A shows a cross-sectional view of a portion of GRIN LC system 1300 that includes a first light-blocking section 1384 of leakage-reduction element 1382. First light-blocking section 1384 may be positioned and configured to block at least a portion of light scattered by an adjacent region of GRIN LC lens 1340. In the example shown in FIG. 13A, liquid crystal molecules and dye molecules in first light-blocking section 1384 may be oriented in conjunction with an exemplary wave vector ke such that a transmission axis of E-ray 1347e is generally or substantially perpendicular to a displacement field vector De of the dye molecules (i.e., the transmission axis of E-ray 1347e and the long molecular axes of the dye molecules are substantially oriented at azimuthal angles of 0° and 90°). Accordingly, the dye molecules may block scattered light, such as E-ray 1347e and/or light scattered at other undesired angles. Because light, such as O-ray 13470, that is not scattered by GRIN LC lens 1340 may pass through first light-blocking section 1384 without being blocked by the oriented dye molecules in first light-blocking section 1384, first light-blocking section 1384 may appear transparent or translucent to a viewer of GRIN LC system 1300. Accordingly, GRIN LC system 1300 may be more visually appealing and may provide greater optical clarity than a GRIN LC lens system that utilizes a dark masking layer or other light blocking feature.

FIG. 13B shows a cross-sectional view of a portion of GRIN LC system 1300 that includes a second light-blocking section 1386 of leakage-reduction element 1382. Second light-blocking section 1386 may be positioned and configured to block leakage of light having undesired polarization states and/or scattered light from an adjacent region of GRIN LC lens 1340. In the example shown in FIG. 13B, liquid crystal molecules and dye molecules in second light-blocking section 1386 may be oriented in conjunction with an exemplary wave vector kₒ such that a transmission axis of O-ray 13470 is generally or substantially perpendicular to a displacement field vector Do of the dye molecules (i.e., the transmission axis of O-ray 13470 and the long molecular axes of the dye molecules are substantially oriented at azimuthal angles of 0° and 90°). The displacement field vector Do shown in FIG. 13B faces substantially normal to the page surface. With the dye molecules oriented in accordance with displacement field vector Do, second light-blocking section 1386 may act as a polarization layer, allowing passage of light that is linearly polarized in polarization direction 1387 shown in FIG. 13B and blocking other light rays that are not sufficiently polarized. In some examples, light that is properly polarized along polarization direction 1387 prior to passing through GRIN LC lens 1340 may take on other polarization states after being scattered. Accordingly, oriented dye molecules in second light-blocking section 1386 may also prevent passage of scattered and/or other leaked light. Accordingly, GRIN LC system 1300 may generate fewer visual disturbances than a GRIN LC system that doesn't provide such selective polarization of light exiting the lens.

FIGS. 14A and 14B illustrate a leakage-reduction element 1482 that includes a GHLC layer 1488 having dye molecules 1492 arranged in a liquid crystal solution. According to some embodiments, liquid crystal molecules 1490 and dye molecules 1492 may be oriented using one or more alignment layers, with or without the aid of an electric filed. For example, as shown in FIGS. 14A and 14B, liquid crystal molecules 1490 and dye molecules 1492 may be oriented in selected directions using one or more alignment layers, such as first and second alignment layers 1489A and 1489B. In this example, the alignment layers may be processed to induce proper alignment and orientation of liquid crystal molecules 1490 and dye molecules 1492 in various regions of leakage-reduction element 1482, including first light-blocking section 1484 shown in FIG. 14A and second light-blocking section 1486 shown in FIG. 14B (see, e.g., first and second light-blocking sections 1284 and 1286 in FIG. 12). FIGS. 14A and 14B additionally illustrate incoming light 1497A incident on a surface of leakage-reduction element 1482 and exiting light 1497B exiting from an opposite surface of leakage-reduction element 1482.

In first light-blocking section 1484 shown in FIG. 14A, a first alignment layer 1489A may be disposed on a first substrate 1494A and a second alignment layer 1489B may be disposed on a second substrate 1494B. GHLC layer 1488 may be disposed between first and second alignment layers 1489A and 1489B such that surfaces of first and second alignment layers 1489A and 1489B contact the liquid crystal solution of GHLC layer 1488. In some examples, liquid crystal molecules 1490 and dye molecules 1492 may be oriented with their long molecular axes extending generally or substantially perpendicular to surface portions of first alignment layer 1489A and/or second alignment layer 1489B. Additionally or alternatively, liquid crystal molecules 1490 and/or dye molecules 1492 may be oriented with their long molecular axes extending at oblique angles relative to surface portions of first alignment layer 1489A and second alignment layer 1489B. In these orientations, dye molecules 1492 of first light-blocking section 1484 may block at least a portion of scattered light (e.g., E-rays) passing through leakage-reduction element 1482 while allowing passage of light (e.g., O-rays) that is aligned along a specified wavefront of an adjacent GRIN LC lens.

In second light-blocking section 1486 shown in FIG. 14B, liquid crystal molecules 1490 and dye molecules 1492 may be oriented with their long molecular axes extending generally or substantially parallel to surface portions of first alignment layer 1489A and second alignment layer 1489B. Additionally or alternatively, liquid crystal molecules 1490 and/or dye molecules 1492 may be oriented with their long molecular axes extending at oblique angles relative to surface portions of first alignment layer 1489A and second alignment layer 1489B. In these orientations, dye molecules 1492 of second light-blocking section 1486 may block at least a portion of scattered light and/or nonpolarized light passing through leakage-reduction element 1482 while allowing passage of light (e.g., polarized O-rays) that is aligned along a specified wavefront of an adjacent GRIN LC lens.

First and second alignment layers 1489A and 1489B may include any material and surface texture suitable for aligning liquid crystal molecules in a desired manner. For example, first alignment layer 1489A and/or second alignment layer 1489B may be formed of a polyimide (PI) material or other suitable material. Additionally, surfaces of first and second alignment layers 1489A and 1489B may be modified in any suitable manner to induce alignment of liquid crystal molecules 1490 and dye molecules 1492 in desired orientations. In at least one example, at least a portion of first alignment layer 1489A and/or second alignment layer 1489B may be formed of a PI layer having a surface that is modified by irradiation with ultraviolet (UV) light to promote curing or partial curing of the PI material. Following UV irradiation, surface portions of first alignment layer 1489A and/or second alignment layer 1489B may be mechanically rubbed in selected directions (e.g., horizontally, circularly, etc.) to provide a substantially consistent surface structure producing predictable surface alignment of liquid crystal molecules 1490 in GHLC layer 1488. Any other suitable material or combination of materials may be included in first and second alignment layers 1489A and 1489B, including, for example, polymers (e.g., perfluoropolyether films), metal-oxides, and/or carbon nanotubes.

In at least one embodiment, first and second alignment layers 1489A and 1489B may be processed in different manners within each of first and second light-blocking sections 1484 and 1486 of leakage-reduction element 1482 to provide different alignment characteristics within each of first and second light-blocking sections 1484 and 1486. For example, first and second alignment layers 1489A and 1489B may be rubbed in different directions within each of first and second light-blocking sections 1484 and 1486. In some examples, during production of first and second alignment layers 1489A and 1489B, the surface of first alignment layer 1489A and/or second alignment layer 1489B may be rubbed in a single direction throughout each of first and second light-blocking regions 1484 and 1486. For example, the alignment surfaces of first alignment layer 1489A and second alignment layer 1489B may each be rubbed in a first linear direction. Such linear rubbing may induce alignments of liquid crystal molecules 1490 and dye molecules 1492 in directions substantially parallel to alignment surfaces of first and second alignment layers 1489A and 1489B, as shown in FIG. 14B. Subsequently, first alignment layer 1489A and/or second alignment layer 1489B in either first light-blocking region 1484 or second light-blocking region 1486 may be further processed to at least partially nullify the effects of the initial rubbing previously applied in the first linear direction. For example, first alignment layer 1489A and second alignment layer 1489B in first light-blocking regions 1484 may be subjected to rubbing in a different direction, such as a circular and/or radial direction(s), to provide alignment characteristics that are distinct from those found in second light-blocking region 1486. Any other suitable mechanical or chemical modification (e.g., laser and/or chemical etching, material deposition, etc.) may be applied to alignment surfaces of first and second alignment layers 1489A and 1489B in first light-blocking regions 1484.

According to various embodiments, the liquid crystal and dye solution of GHLC layer 1488 may include, for example, liquid crystal molecules 1490, dye molecules 1492, and/or additives, such as polymer materials, inorganic materials, and/or twist agents. In the GHLC solution of GHLC layer 1488, liquid crystal molecules 1490 may function as host molecules and dye molecules 1492 may function as guest molecules that are oriented by the host molecules surrounding the guest molecules. Rod-shaped liquid crystal molecules 1490, such as those illustrated in the examples shown in FIGS. 14A and 14B, may be used in GHLC layer 1488 in some examples. Additionally or alternatively, GHLC layer 1488 may include any suitable types of liquid crystal molecules having any other suitable shapes and characteristics, such as, for example, disc-like (i.e., discotic), bowlic (i.e., conic), and/or bent-core liquid crystal molecules. Dye molecules 1492 may include a suitable type of dye or combination of dyes, such as, for example, a dichroic dye (e.g., a rod-shaped dichroic absorption dye). Dye molecules 1492 may be included at concentrations suitable to block a sufficient amount of scattered and/or leaked light and to provide a desired degree of light polarization. Examples of dyes that may be utilized in GHLC layer 1488 include, without limitation, azo, anthraquinone, tetrazine, naphthalimide, perylene, acenequinone, benzothiadiazole, azomethine, indigoid, thioindigoid, merocyanine, azulene, quinophthalonic, phthaloperine, triphenodioxazine, quinoxaline, and triazine dyes.

FIGS. 15A and 15B illustrate a leakage-reduction element 1582 that includes a GHLC layer 1588 having dye molecules 1592 arranged in a liquid crystal solution. According to some embodiments, as shown in FIGS. 15A and 15B, liquid crystal molecules 1590 and dye molecules 1592 may be oriented in a selected direction using electric fields, such as E-fields generated by a voltage differential between first and second electrode layers 1599A and 1599B.

In a light-blocking section 1584 shown in FIGS. 15A and 15B, a first alignment layer 1589A may overlap first electrode layer 1599A and a second alignment layer 1589B may overlap second electrode layer 1599B. According to various examples, first alignment layer 1589A and second alignment layer 1589B may orient liquid crystal molecules 1590 at selected pretilt angles (e.g., angular orientations assumed by liquid crystal molecules 1590 in the absence of an electric field). In some examples, first electrode layer 1599A and second electrode layer 1599B may be disposed on respective substrates 1594A and 1594B. GHLC layer 1588 may be disposed between first alignment layer 1589A and 1589B such that surfaces of first alignment layer 1589A and 1589B contact the liquid crystal solution of GHLC layer 1588.

In some examples, liquid crystal molecules 1590 and dye molecules 1592 may be oriented with their long molecular axes extending generally or substantially perpendicular to surface portions of first alignment layer 1589A and/or second alignment layer 1589B (e.g., when a voltage differential is not applied between first and second electrode layers 1599A and 1599B, as illustrated in FIG. 15A). Additionally or alternatively, liquid crystal molecules 1590 and/or dye molecules 1592 may be oriented with their long molecular axes extending at oblique angles relative to surface portions of first alignment layer 1589A and/or second alignment layer 1589B. In these orientations, dye molecules 1592 of light-blocking section 1584 may block at least a portion of scattered light (e.g., E-rays) passing through leakage-reduction element 1582 while allowing passage of light (e.g., O-rays) that is aligned along a specified wavefront of an adjacent GRIN LC lens.

Changing a voltage differential applied between first and second electrode layers 1599A and 1599B may produce changes in orientations of liquid crystal molecules 1590 and dye molecules 1592. In light-blocking section 1584 shown in FIG. 15B, liquid crystal molecules 1590 and dye molecules 1592 may be oriented with their long molecular axes extending generally or substantially parallel to surface portions of first alignment layer 1589A and second alignment layer 1589B (e.g., when an increased voltage differential is applied between first and second electrode layers 1599A and 1599B, as illustrated in FIG. 15B). Additionally or alternatively, liquid crystal molecules 1590 and/or dye molecules 1592 may be oriented with their long molecular axes extending at oblique angles relative to surface portions of first alignment layer 1589A and second alignment layer 1589B. In these orientations, dye molecules 1592 of light-blocking section 1584 may block at least a portion of scattered light and/or nonpolarized light passing through leakage-reduction element 1582 while allowing passage of light (e.g., polarized O-rays) that is aligned along a specified wavefront of an adjacent GRIN LC lens.

Voltages may be applied to first and second electrode layers 1599A and 1599B to orient liquid crystal molecules 1590 and dye molecules 1592 in desired directions in various regions of leakage-reduction element 1582 at selected times. In some examples, the voltages applied to first and second electrode layers 1599A and 1599B may be maintained at relatively consistent levels during use, thus maintaining specified liquid crystal and dye orientations. In some examples, at least one of first electrode layer 1599A and second electrode layer 1599B may have shape(s) corresponding to defined shapes of various light-blocking sections, which may, for example, have circular or ring shapes (see, e.g., first and second light-blocking sections 1284 and 1286 shown in FIG. 12). In some examples, one of the electrodes, such a first electrode layer 1599A, may act as a common electrode that substantially overlaps an entire surface of leakage-reduction element 1582 (e.g., first electrode layer 1599A may have a generally circular or lens shaped periphery corresponding to the periphery of leakage-reduction element 1282 shown in FIG. 12). Other electrode portions, including second electrode layer 1599B, may be divided into multiple driving electrodes (i.e., GHLC driving electrodes) having circular and/or ring shapes matching shapes of overlapping first light-blocking sections and/or second light-blocking sections (see, e.g., first and second light-blocking sections 1284 and 1286 in FIG. 12).

In certain embodiments, separate driving electrodes (e.g., electrodes located at or near second electrode layer 1599B) may be independently controlled by a controller such that voltages may be selectively applied to each of the driving electrodes. In at least one example, a display system having leakage-reduction element 1582 may also have an eye-tracking system to detect a gaze direction for each of a user's eyes. Such an eye-tracking system may detect a user's eye gaze direction and a controller may apply voltages only to driving electrodes at or near the user's gaze direction, thus conserving power required to operate leakage-reduction element 1582. In some examples, a driving electrode layer, such as second electrode layer 1599B, may be further divided into a pixelated grid shape having a plurality of pixel shaped driving electrodes divided and arrayed in rows and columns. Such a layout may enable further fine tuning of the display to accommodate a user's preferences and adjust to the user's gaze direction on the fly. For example, pixels in a region at or near a location determined based on a user's eye gaze direction may be activated. Additionally, pixels outside this region may not be activated until the user changes their gaze to focus on other regions of the GRIN LC lens and display. Any other suitable electrode layouts may additionally or alternatively be utilized.

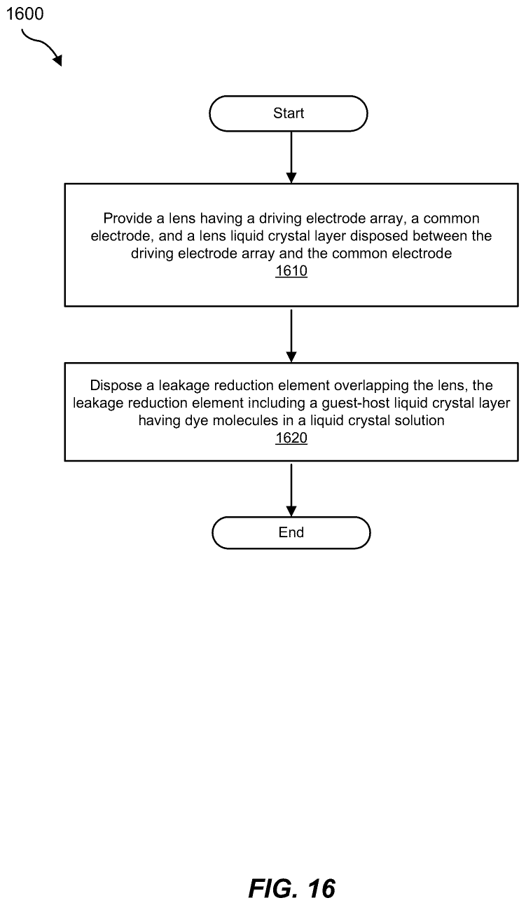

FIG. 16 is a flow diagram of an exemplary method 1600 for manufacturing a GRIN LC system in accordance with embodiments of this disclosure. As illustrated in FIG. 16, at step 1610, a lens may be provided, the lens including a driving electrode array, a common electrode, and a lens liquid crystal layer disposed between the driving electrode array and the common electrode. In some examples, a GRIN LC lens 440 may include a liquid crystal layer 442 disposed between driving electrodes 458 of a driving electrode array and a common electrode 468 (see FIG. 4; see also FIGS. 3, 6A, 6B, 10B, 13A, and 13B).

At step 1620 in FIG. 16, a leakage-reduction element may be disposed overlapping the lens, the leakage-reduction element including a GHLC layer having dye molecules in a liquid crystal solution. For example, a leakage-reduction element 1382 may be disposed overlapping a GRIN LC lens 1340 (see FIGS. 13A and 13B; see also FIGS. 14A, 14B, 15A, and 15B). The leakage-reduction element may include a GHLC layer 1488 having dye molecules 1492 in a solution of liquid crystals 1490 (see FIGS. 14A and 14B; see also FIGS. 13A, 13B, 15A, and 15B).

As described herein, the disclosed display devices and systems may include GRIN LC lenses and overlapping leakage-reduction elements that are positioned and configured to effectively block scattered and non-polarized light rays. GHLC layers included in the leakage-reduction elements may be oriented to block scattered light, including light scattered from the transition regions between Fresnel reset regions. Certain regions of the GHLC layers may also be configured to filter out non-polarized light (e.g., light not polarized in a selected linear direction). Orientations of liquid crystal and dye molecules in regions of the GHLC layers may be directed by alignment layers abutting the GHLC layers and/or by electric fields generated by electrodes overlapping the GHLC layers.

The disclosed leakage-reduction elements may obviate the need to utilize a dark masking layer or other blocking layer to reduce undesirable light scattering and/or leakage. Thus, optical characteristics of GRIN LC lenses having Fresnel resets may be improved, resulting in reduced light scattering and increased clarity. Visible lines, such as those evident on a dark masking layer, may not be present in the disclosed lens systems, which permit light passage through each of the first and second light-blocking regions. The thickness of a leakage-reduction element, as described herein, may be comparatively thin. Accordingly, lens systems including a GRIN lens and an overlapping GHLC-based leakage-reduction layer may be significantly thinner than conventional lens systems. As such, the lens systems described herein may have minimal space requirements, making them suitable for use in a variety of display systems, including various head-mounted display systems.

### EXAMPLE EMBODIMENTS

Example 1: A lens system includes a lens having a driving electrode array, a common electrode, and a lens liquid crystal layer disposed between the driving electrode array and the common electrode. The lens system also includes leakage-reduction element overlapping the lens, the leakage-reduction element including a guest-host liquid crystal (GHLC) layer having dye molecules in a liquid crystal solution.

Example 2: The lens system of Example 1, where the leakage-reduction element is configured to block a portion of light waves passing through the lens.

Example 3: The lens system of Example 2, where the portion of light waves blocked by the leakage-reduction element include light waves that are scattered in directions not aligned along a specified wavefront of the lens.

Example 4: The lens system of any of Examples 1-3, where the dye molecules in the GHLC layer include dichroic dye molecules.

Example 5: The lens system of any of Examples 1-4, where orientations of the dye molecules in the GHLC layer correspond to orientations of liquid crystal molecules in the liquid crystal solution.

Example 6: The lens system of any of Examples 1-5, where the leakage-reduction element includes a pair of alignment layers, with the GHLC layer disposed between the pair of alignment layers.

Example 7: The lens system of any of Examples 1-6, where the leakage-reduction element includes at least two light-blocking sections and the dye molecules are oriented in different directions within the at least two light-blocking sections.

Example 8: The lens system of Example 7, where the at least two light-blocking sections include a first light-blocking section configured to primarily block extraordinary light rays (E-rays) from the lens and a second light-blocking section configured to primarily block ordinary light rays (O-rays) from the lens.

Example 9: The lens system of any of Examples 7 and 8, where the at least two light-blocking sections include 1) a first light-blocking section in which a first portion of the dye molecules are oriented with their long molecular axes extending generally parallel to an alignment surface of the leakage-reduction element and 2) a second light-blocking section in which a second portion of the dye molecules are oriented with their long molecular axes extending obliquely or generally perpendicular to the alignment surface of the leakage-reduction element.

Example 10: The lens system of any of Examples 7-9, where the leakage-reduction element includes an alignment layer abutting the GHLC layer and a surface of the alignment layer includes a first alignment region overlapping a first light-blocking section and a second alignment region overlapping a second light-blocking section.

Example 11: The lens system of Example 10, where the first alignment region and the second alignment region are configured to orient abutting liquid crystal molecules in different directions.

Example 12: The lens system of any of Examples 7-11, where the leakage-reduction element includes at least one GHLC electrode for orienting liquid crystal molecules within the GHLC layer and the at least two light-blocking sections include a first light-blocking section that is overlapped by the at least one GHLC electrode and a second light-blocking section that is not overlapped by the at least one GHLC electrode.

Example 13: The lens system of Example 12, where orientations of liquid crystals within the first light-blocking section vary based on a voltage applied to the at least one GHLC electrode.

Example 14: The lens system of any of Examples 1-13, where the lens includes a plurality of Fresnel reset sections concentrically arranged between a center and an outer periphery of the lens.

Example 15: The lens system of Example 14, where the leakage-reduction element includes a set of first light-blocking sections that overlap transition regions between adjacent Fresnel reset sections.

Example 16: The lens system of Example 15, where the leakage-reduction element includes a set of second light-blocking sections that are each disposed between adjacent first light-blocking sections.

Example 17: The lens system of Example 16, where the second set of light-blocking sections overlap substantial portions of the Fresnel reset sections.

Example 18: A display device includes a display screen having a plurality of light emitting elements and a lens system that receives light emitted from the display screen. The lens system includes a lens having a driving electrode array, a common electrode, and a lens liquid crystal layer disposed between the driving electrode array and the common electrode. The lens system also includes a leakage-reduction element overlapping the lens, the leakage-reduction element including a GHLC layer having dye molecules in a liquid crystal solution.

Example 19: A method includes providing a lens having a driving electrode array, a common electrode, and a lens liquid crystal layer disposed between the driving electrode array and the common electrode. The method also includes disposing a leakage-reduction element overlapping the lens, the leakage-reduction element including a guest-host liquid crystal (GHLC) layer having dye molecules in a liquid crystal solution.

Example 20: The method of Example 19, where the leakage-reduction element includes an alignment layer abutting the GHLC layer. A surface of the alignment layer includes a first alignment region and a second alignment region.

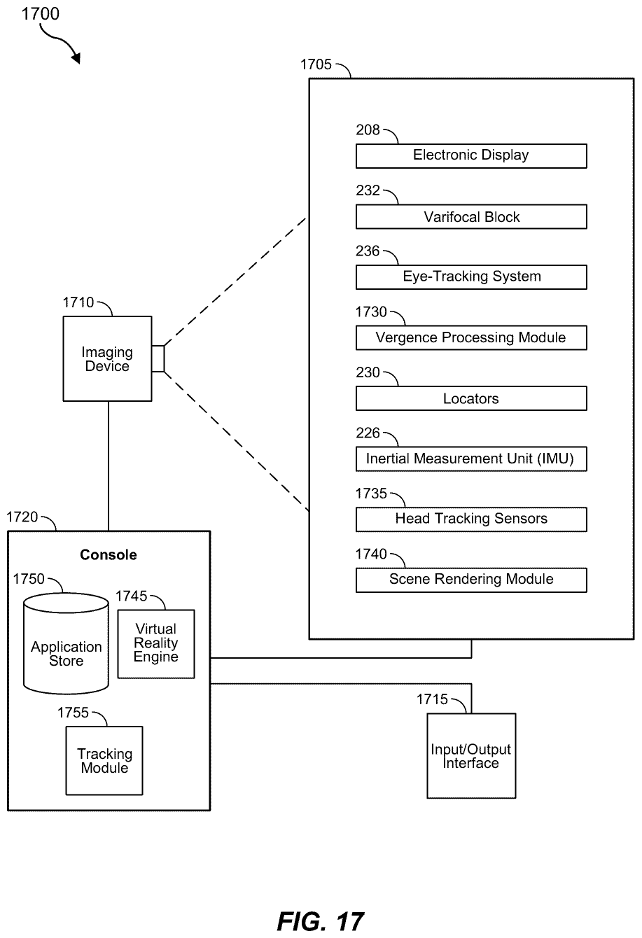

FIG. 17 illustrates an exemplary varifocal system 1700 that includes various aspects of disclosed embodiments. Varifocal system 1700 may be used for a virtual reality system, an augmented reality system, a mixed reality system, or some combination thereof. As shown in FIG. 17, varifocal system 1700 may include an imaging device 1710, a console 1720, an input/output interface 1715, and a head-mounted display (HMD) 1705. Although FIG. 17 shows a single HMD 1705, a single imaging device 1710, and a single input/output interface 1715, any suitable number of these components/subsystems may be included in varifocal system 1700. HMD 1705 may act as a virtual reality, augmented reality, and/or a mixed reality HMD. Various components and/or subsystems of varifocal system 1700 may be physically separated or combined together within a common device and/or assembly. For example, two or more of imaging device 1710, console 1720, input/output interface 1715, and head-mounted display (HMD) 1705 may be combined within an HMD assembly that is worn on a user's head.

HMD 1705 may present content to a user. In some examples, HMD 1705 may be an embodiment of HMD 200 described above with reference to FIGS. 2A and 2B. Example content includes images, video, audio, or some combination thereof. Audio content may be presented via a separate device (e.g., speakers and/or headphones) external to HMD 1705 that receives audio information from HMD 1705, console 1720, or both. HMD 1705 may include an electronic display 208, a varifocal block 232 having one or more GRIN LC lenses as disclosed herein (see, e.g., FIGS. 3-14B), and an eye-tracking system 236 (described above with reference to FIG. 2B). Additionally, HMD 1705 may include one or more locators 230, an internal measurement unit (IMU) 226 (described above with reference to FIG. 2A), a vergence processing module 1730, head tracking sensors 1735, and a scene rendering module 1740.

Eye-tracking system 236 may track eye position and eye movement of a user of HMD 1705. A camera or other optical sensor, which may be part of eye-tracking system 236 inside HMD 1705, may capture image information of a user's eye(s), and eye-tracking system 236 may use the captured information to determine interpupillary distance, interocular distance, a three dimensional (3D) position of each eye relative to HMD 1705 (e.g., for distortion adjustment purposes), including a magnitude of torsion and rotation (i.e., roll, pitch, and yaw), and gaze directions for each eye.

In some embodiments, infrared light may be emitted within HMD 1705 and reflected from each eye. The reflected light may be received or detected by the camera and analyzed to extract eye rotation from changes in the infrared light reflected by each eye. Many methods for tracking the eyes of a user may be used by eye-tracking system 236. Accordingly, eye-tracking system 236 may track up to six degrees of freedom of each eye (i.e., 3D position, roll, pitch, and yaw), and at least a subset of the tracked quantities may be combined from two eyes of a user to estimate a gaze point (i.e., a 3D location or position in the virtual scene where the user is looking). For example, eye-tracking system 236 may integrate information from past measurements, measurements identifying a position of a user's head, and 3D information describing a scene presented by electronic display 208. Thus, information for the position and orientation of the user's eyes may be used to determine the gaze point in a virtual scene presented by HMD 1705 where the user is currently looking.

Varifocal block 232 may adjust its focal length (i.e., optical power) by adjusting a focal length of one or more varifocal structures. As noted above with reference to FIGS. 6A-6C, based on the eye-tracking information, varifocal block 232 may activate one or more LC lenses corresponding to the eye position for each eye of the user, and adjust its focal length by adjusting the voltages applied to the electrodes of the one or more activated LC lenses. Varifocal block 232 may adjust its focal length responsive to instructions from console 1720. Note that a varifocal tuning speed of a varifocal structure is limited by a tuning speed of the LC lenses. Varifocal block 232 may deactivate other LC lenses which are not corresponding to the eye position for each eye of the user, thereby reducing the power consumption of varifocal block 232. In addition, varifocal block 232 may determine a shift between the center of the activated LC lens(es) and the center of the adaptive lens assembly (i.e., a lens center shift).

Vergence processing module 1730 may determine a vergence distance of a user's gaze based on the gaze point or an estimated intersection of the gaze lines determined by eye-tracking system 236. Vergence is the simultaneous movement or rotation of both eyes in opposite directions to maintain single binocular vision, which is naturally and automatically performed by the human eye. Thus, a location where a user's eyes are verged is where the user is currently looking and is also typically the location where the user's eyes are currently focused. For example, vergence processing module 1730 may triangulate the gaze lines to estimate a distance or depth from the user associated with intersection of the gaze lines. Then the depth associated with intersection of the gaze lines may be used as an approximation for the accommodation distance, which identifies a distance from the user where the user's eyes are directed. Thus, the vergence distance may allow determination of a location where the user's eyes should be focused.

Locators 230 may be objects located in specific positions on HMD 1705 relative to one another and relative to a specific reference point on HMD 1705. A locator 230 may be a light emitting diode (LED), a corner cube reflector, a reflective marker, a type of light source that contrasts with an environment in which HMD 1705 operates, or some combination thereof.

IMU 226 may be an electronic device that generates fast calibration data based on measurement signals received from one or more of head tracking sensors 1735, which generate one or more measurement signals in response to motion of HMD 1705. Examples of head tracking sensors 1735 include accelerometers, gyroscopes, magnetometers, other sensors suitable for detecting motion, correcting error associated with IMU 226, or some combination thereof.

Based on the measurement signals from head tracking sensors 1735, IMU 226 may generate fast calibration data indicating an estimated position of HMD 1705 relative to an initial position of HMD 1705. For example, head tracking sensors 1735 may include multiple accelerometers to measure translational motion (forward/back, up/down, left/right) and multiple gyroscopes to measure rotational motion (e.g., pitch, yaw, and roll). IMU 226 may, for example, rapidly sample the measurement signals and calculate the estimated position of HMD 1705 from the sampled data. Alternatively, IMU 226 may provide the sampled measurement signals to console 1720, which determines the fast calibration data.

IMU 226 may additionally receive one or more calibration parameters from console 1720. As further discussed below, the one or more calibration parameters may be used to maintain tracking of HMD 1705. Based on a received calibration parameter, IMU 226 may adjust one or more of the IMU parameters (e.g., sample rate). In some embodiments, certain calibration parameters may cause IMU 226 to update an initial position of the reference point to correspond to a next calibrated position of the reference point. Updating the initial position of the reference point as the next calibrated position of the reference point may help to reduce accumulated error associated with determining the estimated position. The accumulated error, also referred to as drift error, may cause the estimated position of the reference point to “drift” away from the actual position of the reference point over time.

Scene rendering module 1740 may receive contents for the virtual scene from a virtual reality engine 1745 and provide display content for display on electronic display 208. Scene rendering module 1740 may include a hardware central processing unit (CPU), graphics processing unit (GPU), and/or a controller/microcontroller. Additionally, scene rendering module 1740 may adjust the content based on information from eye-tracking system 236, vergence processing module 1730, IMU 226, and head tracking sensors 1735. Scene rendering module 1740 may determine a portion of the content to be displayed on electronic display 208, based on one or more of eye-tracking system 236, tracking module 1755, head tracking sensors 1735, or IMU 226. For example, scene rendering module 1740 may determine a virtual scene, or any part of the virtual scene, to be displayed to the viewer's eyes. Scene rendering module 1740 may also dynamically adjust the displayed content based on the real-time configuration of varifocal block 232. In addition, based on the information of the determined lens center shift provided by varifocal block 232, scene rendering module 1740 may determine a shift of the virtual scene to be displayed on electronic display 208.

Imaging device 1710 may provide a monitoring function for HMD 1705 and may generate slow calibration data in accordance with calibration parameters received from console 1720. Slow calibration data may include one or more images showing observed positions of locators 230 that are detectable by imaging device 1710. Imaging device 1710 may include one or more cameras, one or more video cameras, other devices capable of capturing images including one or more locators 230, or some combination thereof. Slow calibration data may be communicated from imaging device 1710 to console 1720, and imaging device 1710 may receive one or more calibration parameters from console 1720 to adjust one or more imaging parameters (e.g., focal length, focus, frame rate, ISO, sensor temperature, shutter speed, aperture, etc.).

Input/output interface 1715 may be a device that allows a user to send action requests to console 1720. An action request may be a request to perform a particular action. For example, an action request may be used to start or end an application or to perform a particular action within the application. Input/output interface 1715 may include one or more input devices such as a keyboard, a mouse, a game controller, or any other suitable device. An action request received by input/output interface 1715 may be communicated to console 1720, which performs an action corresponding to the action request. In some embodiments, input/output interface 1715 may provide haptic feedback to the user in accordance with instructions received from console 1720. For example, haptic feedback may be provided by input/output interface 1715 when an action request is received, or console 1720 may communicate instructions to input/output interface 1715 causing input/output interface 1715 to generate haptic feedback when console 1720 performs an action.

Console 1720 may provide content to HMD 1705 for presentation to the user in accordance with information received from imaging device 1710, HMD 1705, or input/output interface 1715. In one embodiment, as shown in FIG. 17, console 1720 may include an application store 1750, a tracking module 1755, and a virtual reality engine 1745, etc.

Application store 1750 may store one or more applications for execution by console 1720. An application may be a group of instructions that, when executed by a processor, generate content for presentation to the user. Content generated by an application may be in response to inputs received from the user via movement of HMD 1705 and/or input/output interface 1715. Examples of applications include gaming applications, conferencing applications, video playback applications, and/or other suitable applications.

Tracking module 1755 may calibrate varifocal system 1700 using one or more calibration parameters and may adjust one or more calibration parameters to reduce error in determining position of HMD 1705. For example, tracking module 1755 may adjust the focus of imaging device 1710 to obtain a more accurate position for observed locators 230 on HMD 1705. Moreover, calibration performed by tracking module 1755 may also account for information received from IMU 226. Additionally, when tracking of HMD 1705 is lost (e.g., imaging device 1710 loses line of sight of at least a threshold number of locators 230), tracking module 1755 may re-calibrate some or all of varifocal system 1700 components.

Additionally, tracking module 1755 may track the movement of HMD 1705 using slow calibration information from imaging device 1710, and determine positions of a reference point on HMD 1705 using observed locators from the slow calibration information and a model of HMD 1705. Tracking module 1755 may also determine positions of the reference point on HMD 1705 using position information from the fast calibration information from IMU 226 on HMD 1705. Additionally, tracking module 1755 may use portions of the fast calibration information, the slow calibration information, or some combination thereof, to predict a future location of HMD 1705, which is provided to virtual reality engine 1745.

Virtual reality engine 1745 may function as a controller to execute applications within varifocal system 1700 and may receive position information, acceleration information, velocity information, predicted future positions, or some combination thereof for HMD 1705 from tracking module 1755. Based on the received information, virtual reality engine 1745 may determine content to provide to HMD 1705 for presentation to the user, such as a virtual scene, one or more virtual objects to overlay onto a real-world scene, etc. In some embodiments, virtual reality engine 1745 may maintain focal capability information of varifocal block 232. Focal capability information is information that describes what focal distances are available to varifocal block 232. Focal capability information may include, e.g., a range of focus that varifocal block 232 is able to accommodate (e.g., 0 to 4 diopters) and/or combinations of settings for each activated LC lens that map to particular focal planes. In some examples, virtual reality engine 1745 may operate a GRIN LC lens(es) of varifocal block 232 by controlling voltages applied to driving electrodes and/or common electrodes of the GRIN LC lens(es).

Virtual reality engine 1745 may provide information to varifocal block 232, such as the accommodation and/or convergence parameters including what focal distances are available to varifocal block 232. Virtual reality engine 1745 may generate instructions for varifocal block 232 that cause varifocal block 232 to adjust its focal distance to a particular location. Virtual reality engine 1745 may generate the instructions based on focal capability information and, e.g., information from vergence processing module 1730, IMU 226, and head tracking sensors 1735, and provide the instructions to varifocal block 232 to configure and/or adjust adaptive assembly 232. Virtual reality engine 1745 may use the information from vergence processing module 1730, IMU 226, and/or head tracking sensors 1735 to select a focal plane to present content to the user. Additionally, virtual reality engine 1745 may perform an action within an application executing on console 1720 in response to an action request received from input/output interface 1715 and may provide feedback to the user that the action was performed. The provided feedback may, for example, include visual and/or audible feedback via HMD 1705 and/or haptic feedback via input/output interface 1715.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1800 in FIG. 18) or that visually immerses a user in an artificial reality (such as, e.g., virtual-reality system 1900 in FIG. 19). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 18, augmented-reality system 1800 may include an eyewear device 1802 with a frame 1810 configured to hold a left display device 1815(A) and a right display device 1815(B) in front of a user's eyes. Display devices 1815(A) and 1815(B) may act together or independently to present an image or series of images to a user. While augmented-reality system 1800 includes two displays, embodiments of this disclosure may be implemented in augmented-reality systems with a single NED or more than two NEDs.

In some embodiments, augmented-reality system 1800 may include one or more sensors, such as sensor 1840. Sensor 1840 may generate measurement signals in response to motion of augmented-reality system 1800 and may be located on substantially any portion of frame 1810. Sensor 1840 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1800 may or may not include sensor 1840 or may include more than one sensor. In embodiments in which sensor 1840 includes an IMU, the IMU may generate calibration data based on measurement signals from sensor 1840. Examples of sensor 1840 may include, without limitation, accelerometers, gyroscopes, magnetometers, other suitable types of sensors that detect motion, sensors used for error correction of the IMU, or some combination thereof.

In some examples, augmented-reality system 1800 may also include a microphone array with a plurality of acoustic transducers 1820(A)-1820(J), referred to collectively as acoustic transducers 1820. Acoustic transducers 1820 may represent transducers that detect air pressure variations induced by sound waves. Each acoustic transducer 1820 may be configured to detect sound and convert the detected sound into an electronic format (e.g., an analog or digital format). The microphone array in FIG. 18 may include, for example, ten acoustic transducers: 1820(A) and 1820(B), which may be designed to be placed inside a corresponding ear of the user, acoustic transducers 1820(C), 1820(D), 1820(E), 1820(F), 1820(G), and 1820(H), which may be positioned at various locations on frame 1810, and/or acoustic transducers 1820(I) and 1820(J), which may be positioned on a corresponding neckband 1805.

In some embodiments, one or more of acoustic transducers 1820(A)-(J) may be used as output transducers (e.g., speakers). For example, acoustic transducers 1820(A) and/or 1820(B) may be earbuds or any other suitable type of headphone or speaker.

The configuration of acoustic transducers 1820 of the microphone array may vary. While augmented-reality system 1800 is shown in FIG. 18 as having ten acoustic transducers 1820, the number of acoustic transducers 1820 may be greater or less than ten. In some embodiments, using higher numbers of acoustic transducers 1820 may increase the amount of audio information collected and/or the sensitivity and accuracy of the audio information. In contrast, using a lower number of acoustic transducers 1820 may decrease the computing power required by an associated controller 1850 to process the collected audio information. In addition, the position of each acoustic transducer 1820 of the microphone array may vary. For example, the position of an acoustic transducer 1820 may include a defined position on the user, a defined coordinate on frame 1810, an orientation associated with each acoustic transducer 1820, or some combination thereof.

Acoustic transducers 1820(A) and 1820(B) may be positioned on different parts of the user's ear, such as behind the pinna, behind the tragus, and/or within the auricle or fossa. Or, there may be additional acoustic transducers 1820 on or surrounding the ear in addition to acoustic transducers 1820 inside the ear canal. Having an acoustic transducer 1820 positioned next to an ear canal of a user may enable the microphone array to collect information on how sounds arrive at the ear canal. By positioning at least two of acoustic transducers 1820 on either side of a user's head (e.g., as binaural microphones), augmented-reality device 1800 may simulate binaural hearing and capture a 3D stereo sound field around about a user's head. In some embodiments, acoustic transducers 1820(A) and 1820(B) may be connected to augmented-reality system 1800 via a wired connection 1830, and in other embodiments acoustic transducers 1820(A) and 1820(B) may be connected to augmented-reality system 1800 via a wireless connection (e.g., a BLUETOOTH connection). In still other embodiments, acoustic transducers 1820(A) and 1820(B) may not be used at all in conjunction with augmented-reality system 1800.

Acoustic transducers 1820 on frame 1810 may be positioned in a variety of different ways, including along the length of the temples, across the bridge, above or below display devices 1815(A) and 1815(B), or some combination thereof. Acoustic transducers 1820 may also be oriented such that the microphone array is able to detect sounds in a wide range of directions surrounding the user wearing the augmented-reality system 1800. In some embodiments, an optimization process may be performed during manufacturing of augmented-reality system 1800 to determine relative positioning of each acoustic transducer 1820 in the microphone array.

In some examples, augmented-reality system 1800 may include or be connected to an external device (e.g., a paired device), such as neckband 1805. Neckband 1805 generally represents any type or form of paired device. Thus, the following discussion of neckband 1805 may also apply to various other paired devices, such as charging cases, smart watches, smart phones, wrist bands, other wearable devices, hand-held controllers, tablet computers, laptop computers, other external compute devices, etc.

As shown, neckband 1805 may be coupled to eyewear device 1802 via one or more connectors. The connectors may be wired or wireless and may include electrical and/or non-electrical (e.g., structural) components. In some cases, eyewear device 1802 and neckband 1805 may operate independently without any wired or wireless connection between them. While FIG. 18 illustrates the components of eyewear device 1802 and neckband 1805 in example locations on eyewear device 1802 and neckband 1805, the components may be located elsewhere and/or distributed differently on eyewear device 1802 and/or neckband 1805. In some embodiments, the components of eyewear device 1802 and neckband 1805 may be located on one or more additional peripheral devices paired with eyewear device 1802, neckband 1805, or some combination thereof.

Pairing external devices, such as neckband 1805, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1800 may be provided by a paired device or shared between a paired device and an eyewear device, thus reducing the weight, heat profile, and form factor of the eyewear device overall while still retaining desired functionality. For example, neckband 1805 may allow components that would otherwise be included on an eyewear device to be included in neckband 1805 since users may tolerate a heavier weight load on their shoulders than they would tolerate on their heads. Neckband 1805 may also have a larger surface area over which to diffuse and disperse heat to the ambient environment. Thus, neckband 1805 may allow for greater battery and computation capacity than might otherwise have been possible on a stand-alone eyewear device. Since weight carried in neckband 1805 may be less invasive to a user than weight carried in eyewear device 1802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1805 may be communicatively coupled with eyewear device 1802 and/or to other devices. These other devices may provide certain functions (e.g., tracking, localizing, depth mapping, processing, storage, etc.) to augmented-reality system 1800. In the embodiment of FIG. 18, neckband 1805 may include two acoustic transducers (e.g., 1820(l) and 1820(J)) that are part of the microphone array (or potentially form their own microphone subarray). Neckband 1805 may also include a controller 1825 and a power source 1835.

Acoustic transducers 1820(1) and 1820(J) of neckband 1805 may be configured to detect sound and convert the detected sound into an electronic format (analog or digital). In the embodiment of FIG. 18, acoustic transducers 1820(1) and 1820(J) may be positioned on neckband 1805, thereby increasing the distance between the neckband acoustic transducers 1820(l) and 1820(J) and other acoustic transducers 1820 positioned on eyewear device 1802. In some cases, increasing the distance between acoustic transducers 1820 of the microphone array may improve the accuracy of beamforming performed via the microphone array. For example, if a sound is detected by acoustic transducers 1820(C) and 1820(D) and the distance between acoustic transducers 1820(C) and 1820(D) is greater than, e.g., the distance between acoustic transducers 1820(D) and 1820(E), the determined source location of the detected sound may be more accurate than if the sound had been detected by acoustic transducers 1820(D) and 1820(E).

Controller 1825 of neckband 1805 may process information generated by the sensors on neckband 1805 and/or augmented-reality system 1800. For example, controller 1825 may process information from the microphone array that describes sounds detected by the microphone array. For each detected sound, controller 1825 may perform a direction-of-arrival (DOA) estimation to estimate a direction from which the detected sound arrived at the microphone array. As the microphone array detects sounds, controller 1825 may populate an audio data set with the information. In embodiments in which augmented-reality system 1800 includes an inertial measurement unit, controller 1825 may compute all inertial and spatial calculations from the IMU located on eyewear device 1802. A connector may convey information between augmented-reality system 1800 and neckband 1805 and between augmented-reality system 1800 and controller 1825. The information may be in the form of optical data, electrical data, wireless data, or any other transmittable data form. Moving the processing of information generated by augmented-reality system 1800 to neckband 1805 may reduce weight and heat in eyewear device 1802, making it more comfortable to the user.

Power source 1835 in neckband 1805 may provide power to eyewear device 1802 and/or to neckband 1805. Power source 1835 may include, without limitation, lithium ion batteries, lithium-polymer batteries, primary lithium batteries, alkaline batteries, or any other form of power storage. In some cases, power source 1835 may be a wired power source. Including power source 1835 on neckband 1805 instead of on eyewear device 1802 may help better distribute the weight and heat generated by power source 1835.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1900 in FIG. 19, that mostly or completely covers a user's field of view. Virtual-reality system 1900 may include a front rigid body 1902 and a band 1904 shaped to fit around a user's head. Virtual-reality system 1900 may also include output audio transducers 1906(A) and 1906(B). Furthermore, while not shown in FIG. 19, front rigid body 1902 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1800 and/or virtual-reality system 1900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1800 and/or virtual-reality system 1900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1800 and/or virtual-reality system 1900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more eye-tracking system components may be incorporated into augmented-reality system 1800 in FIG. 18 and/or virtual-reality system 1900 in FIG. 19 to enable these systems to perform various eye-tracking tasks (including one or more of the eye-tracking operations described herein).

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A lens system comprising:
a lens comprising;
a driving electrode array;
a common electrode; and
a lens liquid crystal layer disposed between the driving electrode array and the common electrode; and
a leakage-reduction element overlapping the lens, the leakage-reduction element comprising a guest-host liquid crystal (GHLC) layer comprising dye molecules in a liquid crystal solution.

2. The lens system of claim 1, wherein the leakage-reduction element is configured to block a portion of light waves passing through the lens.

3. The lens system of claim 2, wherein the portion of light waves blocked by the leakage-reduction element include light waves that are scattered in directions not aligned along a specified wavefront of the lens.

4. The lens system of claim 1, wherein the dye molecules in the GHLC layer comprise dichroic dye molecules.

5. The lens system of claim 1, wherein orientations of the dye molecules in the GHLC layer correspond to orientations of liquid crystal molecules in the liquid crystal solution.

6. The lens system of claim 1, wherein the leakage-reduction element comprises a pair of alignment layers, with the GHLC layer disposed between the pair of alignment layers.

7. The lens system of claim 1, wherein:
the leakage-reduction element comprises at least two light-blocking sections; and
the dye molecules are oriented in different directions within the at least two light-blocking sections.

8. The lens system of claim 7, wherein the at least two light-blocking sections comprise:
a first light-blocking section configured to primarily block extraordinary light rays (E-rays); and
a second light-blocking section configured to primarily block ordinary light rays (O-rays).

9. The lens system of claim 7, wherein the at least two light-blocking sections comprise:
a first light-blocking section in which a first portion of the dye molecules are oriented with their long molecular axes extending generally parallel to an alignment surface of the leakage-reduction element; and
a second light-blocking section in which a second portion of the dye molecules are oriented with their long molecular axes extending obliquely or generally perpendicular to the alignment surface of the leakage-reduction element.

10. The lens system of claim 7, wherein:
the leakage-reduction element comprises an alignment layer abutting the GHLC layer; and
a surface of the alignment layer comprises a first alignment region overlapping a first light-blocking section and a second alignment region overlapping a second light-blocking section.

11. The lens system of claim 10, wherein the first alignment region and the second alignment region are configured to orient abutting liquid crystal molecules in different directions.

12. The lens system of claim 7, wherein:
the leakage-reduction element comprises at least one GHLC electrode for orienting liquid crystal molecules within the GHLC layer; and
the at least two light-blocking sections comprise a first light-blocking section that is overlapped by the at least one GHLC driving electrode and a second light-blocking section that is not overlapped by the at least one GHLC driving electrode.

13. The lens system of claim 12, wherein orientations of liquid crystals within the first light-blocking section vary based on a voltage applied to the at least one GHLC driving electrode.

14. The lens system of claim 1, wherein the lens comprises a plurality of Fresnel reset sections concentrically arranged between a center and an outer periphery of the lens.

15. The lens system of claim 14, wherein the leakage-reduction element comprises a set of first light-blocking sections that overlap transition regions between adjacent Fresnel reset sections.

16. The lens system of claim 15, wherein the leakage-reduction element comprises a set of second light-blocking sections that are each disposed between adjacent first light-blocking sections.

17. The lens system of claim 16, wherein the second set of light-blocking sections overlap substantial portions of the Fresnel reset sections.

18. A display device comprising:
a display screen having a plurality of light emitting elements; and
a lens system that receives light emitted from the display screen, the lens system comprising;
a lens comprising:
a driving electrode array;
a common electrode; and
a lens liquid crystal layer disposed between the driving electrode array and the common electrode; and
a leakage-reduction element overlapping the lens, the leakage-reduction element comprising a guest-host liquid crystal (GHLC) layer comprising dye molecules in a liquid crystal solution.

19. A method comprising:
providing a lens comprising;
a driving electrode array;
a common electrode; and
a lens liquid crystal layer disposed between the driving electrode array and the common electrode; and
disposing a leakage-reduction element overlapping the lens, the leakage-reduction element comprising a guest-host liquid crystal (GHLC) layer comprising dye molecules in a liquid crystal solution.

20. The method of claim 19, wherein:
the leakage-reduction element comprises an alignment layer abutting the GHLC layer; and
a surface of the alignment layer comprises a first alignment region and a second alignment region.
